(19) United States
(12) Patent Application Publication
(10) Pub. No.: US 2009/0208675 A1
(43) Pub. Date: Aug. 20, 2009

(54) INKJET RECORDING MEDIA FOR RECORDING SPARKLING METALLIC OR SEMI-METALLIC IMAGES WITH AN INK RECEPTIVE SURFACE FOR RECORDING OF A NEGATIVE OR POSITIVE IMAGE AND AN ADHESIVE TOP OR BOTTOM LAYER THAT MAY BE OPTIONALLY RENDERED OPAQUE AND AN OPTIONALLY REMOVABLE PROTECTIVE LAYER WHEREIN THE ADHESIVE LAYER SURFACE CAN BE APPLIED TO TEXTILE ARTICLES OF COMMERCE

(76) Inventor: Asutosh Nigam, Menlo Park, CA (US)

Correspondence Address: J.G. MULLINS, P.O. Box 641391, San Jose, CA, 95164, US

(21) Appl. No.: 12/430,891

(22) Filed: Apr. 27, 2009

Related U.S. Application Data
(63) Continuation-in-part of application No. 11/955,336, filed on Dec. 12, 2007, now abandoned.
(60) Provisional application No. 60/995,322, filed on Sep. 26, 2007.
(60) Provisional application No. 60/918,452, filed on Mar. 16, 2007.

(51) Int. Cl. B41M 5/00

(52) U.S. Cl. 428/32.1

(57) ABSTRACT

The present invention provides textile articles of commerce and their production via a method for applying a sparkling reflective, luminescent, semi-metallic, or metallic image to a receptor element having valleys or pores, which comprises the steps of (i) providing a transfer sheet comprising a support having a first surface and a second surface and having printable ink receiving media as a top layer for recording a positive or negative sparkling, reflective, luminescent, semi-metallic, or metallic image comprising a sparkly reflective, luminescent, semi-metallic or metallic substrate coated with a semi-opaque or opaque primarily inorganic and/or organic polymeric porous particles and a binder containing ink-receptive layer that is rendered semi-translucent or translucent upon recording of an ink image, and a coating capable of receiving an image on the first or second surface of the support, (ii) imaging the coating with a positive or negative image, (iii) dry peeling the coating from the support in the absence of wet release prior to hand ironing or using a heat press process before applying a light or chemical catalyzed adhesive method when the image is a positive, or optionally dry peeling the coating after hand heat pressing if the image is a negative image, (iv) positioning the optionally dry peeled coating on a receptor element having valleys or pores, (v) positioning a non-stick sheet on the dry peeled coating which is positioned on the receptor element having valleys or pores for manual or machine heat pressing or prior to applying a light or chemical catalyzed adhesive method, and (vi) heat pressing the non-stick sheet to drive the dry peeled coating into the receptor element having valleys or pores, or apply a light or chemical adhesive method to adhere the transfer sheet to the element having valleys or pores.

### FIELD OF THE INVENTION

The field of the present invention relates to a method for applying a light-emitting, reflective, luminescent, holographic, semi-metallic, or metallic or sparkling metallic positive or negative image, such as printed or silk-screen images, to a receptor element having valleys or pores to a receptor element using one or more heat transfer steps, or by utilizing a light or chemical catalyzed adhesion method.

### BACKGROUND OF THE INVENTION

There is a keen demand for substrates that meet high quality standards with respect to brightness, opacity, and dry and/or wet strength, and that, upon printing with any of a wide range of colorants, provide a water-resistant printed image. The ability of such substrates to yield a printed substrate having high resolution and clarity without bleeding or mottling of the image, even when using ink jet printing has become in very high demand. Also, such substrates need to have appropriately smooth or textured surfaces that can be easily received by a non-impact printing system and to avoid curling surfaces that can clog printing equipment. Customers further demand that such substrates be amenable to use with a variety of printing techniques, including not only conventional printing techniques, but also “impact free” printing techniques such as inkjet printing (particularly colored inkjet printing), laser printing, photocopying, and the like.

Further, there is a great demand for printable substrates having an opaque or semi-opaque outer layer on their surface that can be rendered clear or semi-opaque to produce a printed medium that is useful in advertising and/or for producing attractive transfer sheets on textile on products. Particularly needed are printable substrates with high enough quality to be suitable for printing of a digital image with an ink-jet printer, wherein the outer layer of the substrate is capable of being rendered either semi-opaque or clear is constructed upon a clear, semi-opaque, colored, or a reflective substrate layer (such as a metallic looking reflective, holographic, or sparkly substrate layer).

Consumers' interest in T-shirts, sweatshirts, and other fabric materials with customized images (i.e., photos, messages, illustrations, and the like) continues to grow in the United States and elsewhere. Today, consumers use personal computers and desktop printers to create images on a variety of fabrics. Generally, the process involves generating a computerized image and sending it to an ink-jet printer that prints the image onto an ink-jet transfer paper. Commercially-available ink-jet transfer papers typically comprise a support (silicone coated release) paper having a surface coated with a “hot-melt” layer and “ink-receptive” imaging layer that overlays the “hot-melt” layer. Today, most inkjet transfer papers are designed for use to transfer non light emitting images only. However, the transfer sheet described in previous work within this field produces only non-light-emitting transferred images.

Various methods can be used to transfer the image to the fabric. In one instance, a person places the imaged paper over the fabric so that the image is facing down. Then, the person irons or heat press the back surface of the paper with a hand iron. After completely transferring the image onto the fabric, the person removes the support paper after it has cooled or while it is still hot. The surface of the support paper may be coated with silicone so that a person can easily peel the paper off after it has cooled. Ink-jet transfer papers having a silicone coating are commonly referred to as “cold-peel” papers. Ink-jet transfer papers that do not possess a silicone or other non-stick coating are commonly referred to as “hot-peel” papers, since they are peeled-off the fabric while the paper is still hot

In one market such substrates are particularly desired that have the ability to produce a metallic-looking image on the substrate, and perhaps even a holographic image. Also, clear base substrates having an adhesive outer layer or opaque substrates having a backing for applying to textile articles of commerce are particularly in demand. A particularly high demand is for holographic transfer labeling or appending, since this is very difficult and expensive to produce and can be in high demand if an appropriate quality label or transfer element can be produced.

Published U.S. Patent application 2001/0051217 A1 (hereinafter 51217 application) relates to a process for producing a light-emitting, glossy, reflective or metallic-looking image utilizing opaque coating compositions on a reflective, glossy, or luminescent substrate wherein the original surface of the substrate is initially masked but, after being contacted with a recording liquid, becomes transparent, revealing the glossy, reflective or luminescent substrate through the contacted, coated area. The opaque coating compositions are composed of a mixture of a polyacid and a polybase and may be used to treat a substrate either during or after manufacture. Substrates treated with the present opaque coating compositions can be used to yield high quality light-emitting, glossy, reflective, or metallic-looking images. However, quality control is required to avoid permanent finger prints when the recorded media is handled at higher temperatures and compositions must be carefully controlled to avoid cracking and peeling of the recorded coating layer from a metallic, foil or holographic substrate.

The above technology is based upon a coated inkjet receptor layer useful for inkjet photographic printing, which is based on a polymeric resin-type coating rather than on micro porous coatings. In such designs, at least one polymeric receiver swells to absorb the ink solvent vehicle, and inkjet dyes are fixed by cationic sites on the binder or on receiving layer additives. While resin-coated receivers offer many advantages, they also have some common shortcomings, including slow dry times, tackiness under high humidity conditions, and coating solubility or softening when exposed to water. In addition, at warmer temperatures the pressure from finger prints may leave permanent impressions on the printed media.

Micro porous coatings including gelatins have been utilized to try to eliminate some of the problems often associated with polymeric coatings in the glossy or matte photographic printable media, but not in semi-metallic, holographic, light-emitting or luminescent image media. While ink-receptive layers based upon micro porous coatings in glossy or matte inkjet media may have been helpful to eliminate or reduce many of the shortcomings of the polymeric coated media with regard to dry time, tackiness, and water sensitivity, many still suffer from significantly poorer performance in light-fastness and ozone-fastness. In addition, they generally have lower gloss and less ink density receptivity compared to resin coated media, and have not been utilized with any success in semi-metallic, holographic, light-emitting or luminescent printed media. The heat transfer of the printed micro-porous media which produces light-emitting, reflective, luminescent, holographic, semi-metallic, or metallic positive or negative image (printed images) to a receptor element having valleys or pores using one or more heat transfer steps, or by utilizing a light or chemical catalyzed adhesion method is not known. The preferred printing process for such a substrate is using an inkjet printer for SOHO applications but other conventional commercial printing method such as flexo, offset, gravure, laser, dye sublimation printing processes can also be used.

Regarding the field of textiles with recorded images thereon, the major user of color copiers to create personalized transfers are copy shops (e.g. Kinko's) which use commercial laser color copiers, such as the Canon #500/700/800 or the Xerox Spectrum. The machines cost $30,000 and more. A commercial heat press is required to provide a transfer to textile articles of commerce.

Because a commercial press is necessary, the stores must also carry an inventory of apparel since the consumer can not shop elsewhere and apply a transfer at home. Presently, transferring images to receptor elements require costly machines, combined with the requirement for an inventory of apparel, a commercial and costly heat press (e.g. $4,000⁺). These demands prevent consumers from having easy access within the course of one's everyday living experience. Further, there is no effective method for providing a light emitting, reflective, luminescent, holographic, semi-metallic, or metallic image with such a process or an alternative do it at home type process.

One problem in the art is that the internal heat of toner laser imaging devices exceeds the melt point of any “hand-ironable” (can also be referred to as “manual pressable”) transfer. The problem has been apparent for 20 years when Xerox introduced its first commercial toner color copier. In 20 years, no one has found a successful method to achieve hand ironing of toner laser transfers. In addition, providing a transfer with a recorded a light emitting, reflective, luminescent, holographic, semi-metallic, or metallic image, or an article of commerce where such an image can be recorded is difficult due to problems with fading or cracking of the image during or after the transfer to the textile article of commerce.

Accordingly, there is a strong need in the art for improved light-emitting, reflective, luminescent, holographic, semi-metallic, or metallic image inkjet printable photographic media of economical cost having an improved quality control, durability and water fastness without cracking or having extended drying times. There is particular need for textile articles having such images printed thereon.

### DEFINITIONS

It must be noted that, as used in the specification and the appended claims, the singular forms “a,” “an” and “the” include plural referents unless the context clearly dictates otherwise. Thus, for example, reference to “a monomeric compound” in a polymer means that more than one monomeric compound or a mixture of monomeric composition to form a homopolymer or a mixed polymer, such as copolymer, the term copolymer may mean that two or more different types of monomeric units can be present in the composition, reference to “a binder” in a composition means that more than one film-forming binder can be present in the composition, reference to “a coating agent” includes mixtures of different coating agents, and the like.

The term “paper” or “paper substrate” with reference to the ink-jet recording medium is meant to encompass any substrate based on cellulosic fibers; synthetic polymer films and fibers such as polyamides, polyesters, polyethylene, and polyacrylic; inorganic fibers such as asbestos, ceramic, and glass fibers; and any combination of cellulosic, synthetic, and inorganic fibers or a combination of cellulosic fiber and synthetic polymer films produced by extrusion or coating the cellulosic fiber substrate. The paper or paper substrate can be composed of compressed natural or synthetic fibers, of compressed natural or synthetic solids, or of a woven appearance such as a textile or canvas. The paper or paper substrate may be an opaque or a see-through substrate such as used with an overhead projector, and the substrate may be of any dimension (e.g., size or thickness) or form (e.g., pulp, wet paper, dry paper, etc.). Also, the paper or paper substrate can have a smooth or textured appearance, e.g., a canvas-look texture. In most instances, the “paper” or “paper substrate” has been subjected to an external sizing process or coating process in case of release liners such as silicone or polyethylene, polypropylene coated release liners prior to treatment according to the methods of the invention, however sizing is not required. The paper substrate is preferably in the form of a flat or sheet structure, which structure may be of variable dimensions (e.g., size and thickness). “Paper” is meant to encompass printing paper (e.g., inkjet printing paper, etc.), writing paper, drawing paper, and the like, as well as board materials such as cardboard, poster board, Bristol board, and the like.

The term “sheet” or “flat structure” is not meant to be limiting as to dimension, roughness, or configuration of the substrate useful with the present invention, but rather is meant to refer to a product suitable for coating. A sheet or flat structure can refer to a substrate having either a substantially smooth or a textured appearance, e.g., a canvas-look texture.

“Sized paper substrate” is a paper substrate as described above that has applied to its surface and/or is saturated with a sizing composition. Sizing compositions may be applied in an internal sizing step and/or in an external sizing step; preferably sizing (e.g., internal and/or external sizing) occurs prior to application of the coating composition of the invention.

“Coated paper substrate” is a paper substrate that has applied to its surface and/or is saturated with a heat transferable coating composition of the invention. Coating compositions may be applied as a pre-treatment (e.g., prior to printing), simultaneously with printing, or as an after-treatment. The coating compositions of the invention are applied in one or more coatings on plain papers, clay-coated papers, and resin-coated papers such as polyethylene, polypropylene or silicone coated papers and latex-impregnated papers in quantities suitable to provide the desired characteristics, such as bleed resistance, heat transfer in desired temperature range, wash resistance (e.g., non washable) of an ink printed on coated paper substrate, etc. One or more coatings may be applied to achieve desired properties.

“Aqueous based ink” refers to an ink composed of an aqueous carrier medium (or composed of a mixed solvent medium such as a mixture of aqueous and aqueous miscible organic solvents) and a colorant, such as a dye or a pigment dispersion. An “aqueous carrier medium” is composed of water or a mixture of water and one or more water-soluble organic solvents. Exemplary aqueous based ink compositions are described in detail below. However a substrate can be printed with all organic solvent based ink system as well.

“Colorant” as used herein is meant to encompass one or more organic dyes, inorganic dyes, pigments, stains, and the like compatible for use with the polymer coatings of the invention. A colorant may be in the RGB scale, the CMY scale, or simply a white or black opaque pigment. Examples of opaque pigments are aluminas, silicas, and titanium oxide. Examples of organic pigments are micronized organic polymers that are usually not soluble in water.

The term “organic solvent” is used herein in its conventional sense to refer to a liquid organic compound, typically a monomeric organic material in the form of a liquid, preferably a relatively non-viscous liquid, the molecular structure of which contains hydrogen atoms, carbon atoms, and optionally other atoms as well, and which is capable of dissolving solids gases or liquids.

The term “predominantly”, as when used with reference to the composition of a mixture of materials or a polymer, generally refers to the presence of more than 50% of the item in either a mixture or compound by percentage weight or by percentage of units, depending on the context.

The term “mainly”, as when used with reference to the composition of a mixture of materials or a polymer, generally refers to the presence of more than 75% of the item in either a mixture or compound by percentage weight or by percentage of units, depending on the context.

The term “opaque”, when used herein refer to a material that is not transparent (but may optionally have a uniform color, multiple colors, or particles of color) and images cannot be seen through it at all, or only slightly and not clearly.

The term “semi-opaque” refers to a material that is only slightly translucent such that it may have a milky appearance or show printed material in a fuzzy focus sort of way.

The terms “hand iron” or “manual press” and their derivative gerunds and verbs terms as used herein refer to the use of a small hand-held heating and pressing device (such as an iron for ironing clothes) or a small manually operated press, rather than a large automated industrial fabric pressing machine.

The term “wash resistance” is used herein to describe the resistance of transferred image to during wash cycles, with the term “wash resistance” specifically referring to resistance of image to be non removable in multiple regular detergent wash cycles.

The term “alkyl” as used herein refers to a branched or unbranched saturated hydrocarbon group of 1 to 24 carbon atoms, such as methyl, ethyl, n-propyl, isopropyl, n-butyl, isobutyl, t-butyl, octyl, decyl, tetradecyl, hexadecyl, eicosyl, tetracosyl and the like, as well as cycloalkyl groups such as cyclopentyl, cyclohexyl and the like. The term “lower alkyl” intends an alkyl group of 1 to 10 carbon atoms, preferably from 1 to 4 carbon atoms.

The term “alkylene” as used herein refers to a difunctional, branched or unbranched saturated hydrocarbon group of 1 to 24 carbon atoms, including without limitation methylene, ethylene, ethane-1,1-diyl, propane-2,2-diyl, propane-1,3-diyl, butane-1,3-diyl, and the like. “Lower alkylene” refers to an alkylene group of 1 to 6 carbon atoms.

The terms “organic acyl”, “alkanoyl”, or “lower alkanoyl” or as used herein intends an alkyl group bound to a carbonyl group, and may be bonded to an imine group through the carbonyl group to form a carboxamide group. The alkyl or lower alkyl portion of the alkanoyl or lower alkanoyl, or in the generic term organic acyl, are each defined as described above for “alkyl” or “lower alkyl”.

“Halo” or “halogen” refers to fluoro, chloro, bromo or iodo, and usually relates to halo substitution for a hydrogen atom in an organic compound.

The term “polymer” is used herein in its conventional sense to refer to a compound having about 8 or more monomer units, and unless otherwise stated, refers to a compound having a molecular weight from about 1000 and higher. The term “oligomer” refers to a compound having from 2 to about 8 monomer units. The terms oligomer and polymer intend to cover compounds having a single type of repeating monomer unit (homopolymer or oligomer) as well as compounds containing more than one type of monomer unit (copolymers and mixed oligomers). The terms “monomer” or “monomeric” as used herein refer to compounds which are not polymeric or oligomeric as defined above.

The term “copolymer” of a monomeric component as used herein may refer to a mixed polymer having two or more types of monomeric units. When the copolymer is defined more specifically, the monomeric units are defined by percentages or predominance in the polymer.

The term “inorganic pigment” is used herein for inorganic oxides. Examples of suitable inorganic pigments include silica, alumina, titanium dioxide, zinc sulfide, zinc oxide, antimony oxide, barium sulfate, calcium carbonate, and the like etc.

The term of “polymeric particle” is used here for polymeric organic particles that may or may not contain inorganic pigments. Examples of organic polymeric particles are polyolefin, polyamide, and polyester particles. Preferably, substantially porous thermoplastic particles having a high surface area are used. These particles are better able to absorb water and water-miscible solvents contained in aqueous-based inks. For example, the particles may have a particle size distribution containing particles with a diameter size in the range of 5 μm to 100 μm and are mostly thermoplastic polymers.

“Optional” or “optionally” means that the subsequently described event or circumstance may or may not occur, and that the description includes instances where said event or circumstance occurs and instances where it does not. For example, the phrase “optionally substituted” aromatic ring means that the aromatic ring may or may not be substituted and that the description includes both an unsubstituted aromatic ring and an aromatic ring bearing one or more substituents. Also, by way of example, when a component may be optionally included in a mixture it may be present or entirely absent.

### SUMMARY OF THE INVENTION

An object of the invention is to provide a method for applying a light-emitting, reflective, luminescent, holographic, semi-metallic, or metallic image to a receptor element having valleys or pores, which comprises the steps of (i) providing a transfer sheet comprising a support having a first surface and a second surface and having printable ink receiving media as a top layer for recording a positive or negative light-emitting, reflective, luminescent, holographic, semi-metallic, or metallic image comprising a light-emitting, reflective, luminescent, holographic, semi-metallic or metallic substrate coated with a semi-opaque or opaque primarily inorganic and/or organic polymeric porous particles and a binder containing ink-receptive layer that is rendered semi-translucent or translucent upon recording of an ink image, and a coating capable of receiving an image on the first or second surface of the support, (ii) imaging the coating with a positive or negative image, (iii) dry peeling the coating from the support in the absence of wet release prior to hand ironing or using a heat press process before applying a light or chemical catalyzed adhesive method when the image is a positive, or optionally dry peeling the coating after hand heat pressing if the image is a negative image, (iv) positioning the optionally dry peeled coating on a receptor element having valleys or pores, (v) positioning a non-stick sheet on the dry peeled coating which is positioned on the receptor element having valleys or pores for manual or machine heat pressing or prior to applying a light or chemical catalyzed adhesive method, and (vi) heat pressing the non-stick sheet to drive the dry peeled coating into the receptor element having valleys or pores, or apply a light or chemical adhesive method to adhere the transfer sheet to the element having valleys or pores.

Another object of the present invention is to provide an image transfer method that utilizes a hand-held heat transfer device that is available to an ordinary consumer to modify already manufactured textiles to apply a light-emitting, reflective, luminescent, holographic, semi-metallic, sparkling metallic or metallic image to a receptor element having valleys or pores, which comprises the steps of (i) providing a transfer sheet comprising a support (such as a release paper) having a first surface and a second surface and having printable ink receiving layer for recording a positive or negative light-emitting, reflective, luminescent, holographic, semi-metallic, or metallic image comprising a light-emitting, reflective, luminescent, holographic, semi-metallic, sparkling or metallic substrate coated with a semi-opaque or opaque coating, primarily comprised of organic particles and thermoplastic polymers and optionally containing inorganic pigment containing organic particles, ink-receptive layer that is rendered opaque to translucent upon recording of an ink image, and a coating capable of receiving an image on the first or second surface of the support, (ii) imaging the coating with a positive or negative digital image using an inkjet printer, (iii) dry peeling the coating from the support in the absence of wet release prior to hand ironing or before applying a light or chemical catalyzed adhesive method when the image is a positive, or optionally dry peeling the coating after heat pressing if the image is a negative image, (iv) positioning the optionally dry peeled coating on a receptor element having valleys or pores, (v) positioning a non-stick sheet on the dry peeled coating which is positioned on the receptor element having valleys or pores for hand ironing or prior to applying a light or chemical catalyzed adhesive method, and (vi) heating the non-stick sheet to drive the dry peeled coating into the receptor element having valleys or pores, or apply a light or chemical adhesive method to adhere the transfer sheet to the element having valleys or pores.

A further object of the present invention is a method for producing an ink jet or silk screen printable substrate having from at least two layers that is useful in the above method comprising:

(a) providing a thermoplastic transfer substrate layer over a release paper or a similar type peel off transfer backing to which is applied a reflective metallic powder or metallic flakes, metallic layer or other metallic coating, or alternatively, the metallic particles may be incorporated into the thermoplastic transfer substrate layer during its formation, and

(b) applying an inkjet receptive coating, layer or laminate as described above to the thermoplastic layer comprising thermoplastic organic particles, and optionally comprising inorganic pigments other ink receptive polymers as binder, cross linkers, and additives such as surfactants, dispersing agent, and other acceptable functional and non-functional additives.

In one preferred embodiment, the thermoplastic substrate layer is formed as a pluralistic single layer upon a peel-off transfer backing, wherein the thermoplastic substrate layer further comprises the metallic powder or metallic flakes in combination with the ink receptive components to produce a single layer with a removable transfer backing.

A still further object of the present invention is a method for producing an inkjet or silk screen printable substrate as described above that has three layers formed upon a peel-off removable backing, wherein the layer next to the peel-off backing is a thermoplastic layer that can be softened with the heat from a regular fabric ironing device, and the top layer is a porous thermoplastic ink jet or silk screen printable layer, and wherein at least one layer located substantially in between the ink jet or silk screen printable layer and the thermoplastic layer is a metallic layer that is formed by applying a curable or dryable solution that is a liquid or gel and the liquid or gel comprise metallic power, flakes or metallic-like reflective particles, applying metallic particles by metallic sputtering, or applying a metallic laminate layer that may or may not contain a thermoplastic binder.

Yet another object of the present invention is to provide a single or multilayer printable substrate as described above that does not require a peel-off backing and may be appended to a fabric by utilizing the heat or a normal iron or a similar heating process, wherein one surface comprises a thermoplastic layer that is also constructed as an inkjet receptive layer that permits the printing of a negative image upon the thermoplastic surface that will be visible as a positive image once the substrate has been applied to the fabric, and the surface where the positive image may be view may be translucent, semi-translucent, or semi-opaque.

A further object of the invention is to provide a fabric having an shaped area that is formed of a metallic, metallic sparkly, or holographic substrate, wherein the shaped area is obtained from cutting out a desired shape, pattern, logo or the like from a thermoplastic substrate and applying the cut out pattern to the fabric by a thermoplastic heat transfer process similar to the heat and method from an ordinary fabric ironing device.

Another object of the present invention is to provide a textile article comprising a receptor element obtained from one or more textile materials with a transfer sheet adhered to the element, wherein the transfer sheet has a positive or negative light-emitting, reflective, luminescent, holographic, semi-metallic, or metallic image recorded thereon, or may be recorded thereon.

An object of the present invention is to provide an ink printable micro porous photo quality printable ink receiving media layer located upon a thermoplastic heat transferable substrate, or incorporated within a thermoplastic layer of the thermoplastic heat transferable substrate for recording a light-emitting, reflective, luminescent, holographic, semi-metallic, metallic or sparkly metallic image comprising a light-emitting, reflective, luminescent, holographic, semi-metallic or metallic substrate coated with a semi-opaque or opaque coating predominantly containing organic particles and ink-reactive polymer binders to provide an ink-receptive layer that is rendered semi-translucent or translucent upon recording of an ink image, wherein the ink-receptive layer comprises polymeric organic particles, polymer binders and other additives such as surfactant and dispersing agent. The ink receptive layer may optionally contain inorganic pigments as well. Examples of organic polymeric particles are polyolefin, polyamide, and polyester particles. Preferably, substantially porous thermoplastic particles having a high surface area are used. These particles are better able to absorb water and water-miscible solvents contained in aqueous-based inks. For example, the particles may have a particle size distribution containing particles with a diameter size in the range of 5 μm to 100 μm and are predominately thermoplastic polymers. The binder for the ink receptive layer is preferably a polyurethane or polyester binder that is capable of binding porous organic polymeric particles. The ink-receptive layer is capable of absorbing aqueous-based inks from an ink-jet printer to form an image. Most inks used in ink-jet printing devices are aqueous-based inks containing molecular dyes or pigmented colorants. Water is the major component in aqueous-based inks. Small amounts of water-miscible solvents such as glycols and glycol ethers may also be present.

Preferably, the polyurethane binder is used in the ink-receptive layer has a softening point in the range of 500 to 190° C. More preferably suitable polyurethane elastomers are a polyurethane binder containing cationic functional groups. It is believed that such cationic groups are capable of reacting with and stabilizing anionic dyestuffs found in aqueous-based inks. In addition to, polymeric binder other cationic polymers may be used in ink receptive layer such as a polymeric adduct of polyethylenimine and epichlorhydrin also known as azetidinium polymers, aziridine and/or oxazoline functional group containing polymers and monomers etc.

An object of the invention is to provide such a recordable media constructed from any compatible light-emitting, reflective, luminescent, holographic, semi-metallic, metallic or sparkly metallic base layer or substrate that can accept at least one layer of the semi-opaque or opaque primarily organic particles and a polymeric binder ink receptive layer coating thereon, or can incorporate the ink receptive layer as a part of the composition that provides the light-emitting, reflective, luminescent, holographic, semi-metallic or metallic layer. The ink-receptive layer is a topcoat layer that may be optionally coated with a porous ink-transmitting layer, or is a composition that may be incorporate into a metallic composition, a thermoplastic composition, or both.

Another object of the invention is to provide a micro porous photo quality printable ink receiving media for recording a light-emitting, reflective, luminescent, holographic, semi-metallic, or metallic image including a substrate basecoat or layer that is a light-emitting, reflective, luminescent, holographic, semi-metallic, or metallic image substrate base at least partially coated with the micro porous ink-receptive coating layer.

In a preferred object to the present invention, the ink-receptive layer is composed primarily of an organic particle and polymeric binder, optionally further containing one or more cross-linker agents and inorganic porous pigments. Examples of organic polymeric particles are polyolefin, polyamide, and polyester particles. Preferably, substantially porous thermoplastic particles having a high surface area are used. Preferably, the ink-receptive layer is a topcoat layer for an inkjet recordable media that may be optionally further coated with another topcoat layer that is a porous ink-transmitting layer. Optional porous ink-transmitting layers also may be coated over compatible light-emitting, reflective, luminescent, holographic, semi-metallic or metallic base layers or substrate basecoat layers prior to coating of the media with one or more ink receptive layers according to the invention.

An object of the invention is to provide such ink receptive layers wherein the crosslinkers or binders compatible with the other components of the ink receptive layer are selected from group of thermoplastic polyurethanes, polyesters polyamides, copolymers of polyethylene (waxes) etc. The example of useful polymers are; commercially available polyurethanes or polyesters or their copolymers that can be heat melted or fused with receptor surface by hand ironing or heat pressing.

In a preferred object of the invention, the binder for the ink receptive layer is selected from thermoplastic vinyl, polyurethane, polyester, polyamide, polyacrylates, polyolefins, polystyrene and their copolymers alone or in combinations, and the cross linker is selected from an azetidinium or salt cross-linker, an oxazoline derivative cross-linker, or an aziridine base or salt cross-linker.

Another object of the invention is to utilize the above ink receptive coating in combination with any compatible light-emitting, reflective, luminescent, holographic, semi-metallic or metallic base layer or substrate, preferably with an absorbent basecoat layer coated thereon prior to coating of the ink-receptive layer, to provide an ink recordable media, preferably an inkjet-receptive recordable media suitable for photographic or other graphic recording. A preferred basecoat layer includes a combination of an acceptable pigment and binder, and the basecoat may further include deformable particles, such as core-shell polymeric pigments.

A further object of the invention is to provide a method for increasing the gloss, reflectivity, luminescence, metallic-looking image, or holographic-like image or surface smoothness presented by the topcoat of a printing medium by optionally including deformable particles in an underlying basecoat layer or substrate followed by calendaring of the printing medium.

A still further object of the invention is to provide a light-emitting, reflective, luminescent, holographic, semi-metallic or metallic inkjet printing media constructed from a light-emitting, reflective, luminescent, holographic, semi-metallic or metallic base layer or substrate that is at least partially coated with the micro porous ink-receptive coating layer.

### DESCRIPTION THE INVENTION

An embodiment of the invention provides a method for applying a light-emitting, reflective, luminescent, holographic, semi-metallic, or metallic image to a receptor element having valleys or pores, which comprises the steps of (i) providing a transfer sheet comprising a support having a first surface and a second surface and having printable ink receiving media as a top layer for recording a positive or negative light-emitting, reflective, luminescent, holographic, semi-metallic, or metallic image comprising a light-emitting, reflective, luminescent, holographic, semi-metallic or metallic substrate coated with a semi-opaque or opaque primarily inorganic and/or organic polymeric porous particles and a binder containing ink-receptive layer that is rendered semi-translucent or translucent upon recording of an ink image, and a coating capable of receiving an image on the first or second surface of the support, (ii) imaging the coating with a positive or negative image, (iii) dry peeling the coating from the support in the absence of wet release prior to hand ironing or using a heat press process before applying a light or chemical catalyzed adhesive method when the image is a positive, or optionally dry peeling the coating after hand heat pressing if the image is a negative image, (iv) positioning the optionally dry peeled coating on a receptor element having valleys or pores, (v) positioning a non-stick sheet on the dry peeled coating which is positioned on the receptor element having valleys or pores for manual or machine heat pressing or prior to applying a light or chemical catalyzed adhesive method, and (vi) heat pressing the non-stick sheet to drive the dry peeled coating into the receptor element having valleys or pores, or apply a light or chemical adhesive method to adhere the transfer sheet to the element having valleys or pores.

Another embodiment of the invention provides an image transfer method that utilizes a hand-held heat transfer device that is available to an ordinary consumer to modify already manufactured textiles to apply a light-emitting, reflective, luminescent, holographic, semi-metallic, sparkling metallic or metallic image to a receptor element having valleys or pores, which comprises the steps of (i) providing a transfer sheet comprising a support (such as a release paper) having a first surface and a second surface and having printable ink receiving layer for recording a positive or negative light-emitting, reflective, luminescent, holographic, semi-metallic, or metallic image comprising a light-emitting, reflective, luminescent, holographic, semi-metallic, sparkling or metallic substrate coated with a semi-opaque or opaque coating, primarily comprised of organic particles and thermoplastic polymers and optionally containing inorganic pigment containing organic particles, ink-receptive layer that is rendered opaque to translucent upon recording of an ink image, and a coating capable of receiving an image on the first or second surface of the support, (ii) imaging the coating with a positive or negative digital image using an inkjet printer, (iii) dry peeling the coating from the support in the absence of wet release prior to hand ironing or before applying a light or chemical catalyzed adhesive method when the image is a positive, or optionally dry peeling the coating after hand pressing if the image is a negative image, (iv) positioning the optionally dry peeled coating on a receptor element having valleys or pores, (v) positioning a non-stick sheet on the dry peeled coating which is positioned on the receptor element having valleys or pores for hand ironing or prior to applying a light or chemical catalyzed adhesive method, and (vi) heating the non-stick sheet to drive the dry peeled coating into the receptor element having valleys or pores, or apply a light or chemical adhesive method to adhere the transfer sheet to the element having valleys or pores.

A further embodiment of the present invention provides a method for producing an ink jet or silk screen printable substrate having from at least two layers that is useful in the above method comprising:

(a) providing a thermoplastic transfer substrate layer over a release paper or a similar type peel off transfer backing to which is applied a reflective metallic powder or metallic flakes, metallic layer or other metallic coating, or alternatively, the metallic particles may be incorporated into the thermoplastic transfer substrate layer during its formation, and

(b) applying an inkjet receptive coating, layer or laminate as described above to the thermoplastic layer comprising thermoplastic organic particles, and optionally comprising inorganic pigments other ink receptive polymers as binder, cross linkers, and additives such as surfactants, dispersing agent, and other acceptable functional and non-functional additives.

In one preferred embodiment, the thermoplastic substrate layer is formed as a pluralistic single layer upon a peel-off transfer backing, wherein the thermoplastic substrate layer further comprises the metallic powder or metallic flakes in combination with the ink receptive components to produce a single layer with a removable transfer backing.

A still further embodiment of the present invention provides a method for producing an inkjet or silk screen printable substrate as described above that has three layers formed upon a peel-off removable backing, wherein the layer next to the peel-off backing is a thermoplastic layer that can be softened with the heat from a regular fabric ironing device, and the top layer is a porous thermoplastic ink jet or silk screen printable layer, and wherein at least one layer located substantially in between the ink jet or silk screen printable layer and the thermoplastic layer is a metallic layer that is formed by applying a curable or dryable solution that is a liquid or gel and the liquid or gel comprise metallic power, flakes or metallic-like reflective particles, applying metallic particles by metallic sputtering, or applying a metallic laminate layer that may or may not contain a thermoplastic binder.

Yet another embodiment of the present invention provides a single or multilayer printable substrate as described above that does not require a peel-off backing and may be appended to a fabric by utilizing the heat or a normal iron or a similar heating process, wherein one surface comprises a thermoplastic layer that is also constructed as an inkjet receptive layer that permits the printing of a negative image upon the thermoplastic surface that will be visible as a positive image once the substrate has been applied to the fabric, and the surface where the positive image may be view may be translucent, semi-translucent, or semi-opaque.

A further embodiment of the invention provide a fabric having an shaped area that is formed of a metallic, metallic sparkly, or holographic substrate, wherein the shaped area is obtained from cutting out a desired shape, pattern, logo or the like from a thermoplastic substrate and applying the cut out pattern to the fabric by a thermoplastic heat transfer process similar to the heat and method from an ordinary fabric ironing device.

Another embodiment of the present invention provides a textile article comprising a receptor element obtained from one or more textile materials with a transfer sheet adhered to the element, wherein the transfer sheet has a positive or negative light-emitting, reflective, luminescent, holographic, semi-metallic, or metallic image recorded thereon, or may be recorded thereon.

An embodiment of the present invention provides an ink printable micro porous photo quality printable ink receiving media layer located upon a thermoplastic heat transferable substrate, or incorporated within a thermoplastic layer of the thermoplastic heat transferable substrate for recording a light-emitting, reflective, luminescent, holographic, semi-metallic, metallic or sparkly metallic image comprising a light-emitting, reflective, luminescent, holographic, semi-metallic or metallic substrate coated with a semi-opaque or opaque coating predominantly containing organic particles and ink-reactive polymer binders to provide an ink-receptive layer that is rendered semi-translucent or translucent upon recording of an ink image, wherein the ink-receptive layer comprises polymeric organic particles, polymer binders and other additives such as surfactant and dispersing agent. The ink receptive layer may optionally contain inorganic pigments as well. Examples of organic polymeric particles are polyolefin, polyamide, and polyester particles. Preferably, substantially porous thermoplastic particles having a high surface area are used. These particles are better able to absorb water and water-miscible solvents contained in aqueous-based inks. For example, the particles may have a particle size distribution containing particles with a diameter size in the range of 5 μm to 100 μm and are predominately thermoplastic polymers. The binder for the ink receptive layer is preferably a polyurethane or polyester binder that is capable of binding porous organic polymeric particles. The ink-receptive layer is capable of absorbing aqueous-based inks from an ink-jet printer to form an image. Most inks used in ink-jet printing devices are aqueous-based inks containing molecular dyes or pigmented colorants. Water is the major component in aqueous-based inks. Small amounts of water-miscible solvents such as glycols and glycol ethers may also be present.

Preferably, the polyurethane binder that is used in the ink-receptive layer has a softening point in the range of 50° to 190° C. More preferably suitable polyurethane elastomers are a polyurethane binder containing cationic functional groups. It is believed that such cationic groups are capable of reacting with and stabilizing anionic dyestuffs found in aqueous-based inks. In addition to, polymeric binder other cationic polymers may be used in ink receptive layer such as a polymeric adducts of polyethylenimine and epichlorhydrin also known as azetidinium polymers.

Useful polyurethanes include but not limited to are aromatic polyether polyurethanes, aliphatic polyether polyurethanes, aromatic polyester polyurethanes, aliphatic polyester polyurethanes, aromatic polycaprolactam polyurethanes, and aliphatic polycaprolactam polyurethanes. Particularly useful polyurethanes include aromatic polyether polyurethanes, aliphatic polyether polyurethanes, aromatic polyester polyurethanes, and aliphatic polyester polyurethanes.

Examples of some commercial polyurethanes include Sancure 2710® and/or Avalure UR 445® (which are equivalent copolymers of polypropylene glycol, isophorone diisocyanate, and 2,2-dimethylolpropionic acid, having the International Nomenclature Cosmetic Ingredient name “PPG-17/PPG-34/IPDI/DMPA Copolymer”), Sancure 878®, Sancure 815®, Sancure 1301®, Sancure 2715®, Sancure 1828®, Sancure 2026®, Sancure 1818®, Sancure 853®, Sancure 830®, Sancure 825®, Sancure 776®, Sancure 850®, Sancure 12140®, Sancure 12619®, Sancure 835®, Sancure 843®, Sancure 898®, Sancure 899®, Sancure 1511®, Sancure 1514®, Sancure 1517®, Sancure 1591®, Sancure 2255®, Sancure 2260®, Sancure 2310®, Sancure 2725®, and Sancure 12471® (all of which are commercially available from BF Goodrich, Cleveland, Ohio), Bayhydrol DLN (commercially available from Bayer Corp., McMurray, Pa.), Bayhydrol LS-2033 (Bayer Corp.), Bayhydrol 123 (Bayer Corp.), Bayhydrol PU402A (Bayer Corp.), Bayhydrol 110 (Bayer Corp.), Witcobond W-320 (commercially available from Witco Performance Chemicals), Witcobond W-242 (Witco Performance Chemicals), Witcobond W-160 (Witco Performance Chemicals), Witcobond W-612 (Witco Performance Chemicals), Witcobond W-506 (Witco Performance Chemicals), NeoRez R-600 (a polytetramethylene ether urethane extended with isophorone diamine commercially available from Avecia, formerly Avecia Resins), NeoRez R-940 (Avecia Resins), NeoRez R-960 (Avecia Resins), NeoRez R-962 (Avecia Resins), NeoRez R-966 (Avecia Resins), NeoRez R-967 (Avecia Resins), NeoRez R-972 (Avecia Resins), NeoRez R-9409 (Avecia Resins), NeoRez R-9637 (Avecia), NeoRez R-9649 (Avecia Resins), and NeoRez R-9679 (Avecia Resins).

Some useful polyurethanes are aliphatic polyether polyurethanes. Examples of such aliphatic polyether polyurethanes include Sancure 2710® and/or Avalure UR 445®, Sancure 878®, NeoRez R-600, NeoRez R-966, NeoRez R-967, and Witcobond W-320.

In one embodiment, the thermoplastic polymeric binder comprises at least one polyester polyurethane. Examples of these polymeric core include those sold under the names “Sancure 2060” (polyester-polyurethane), “Sancure 2255” (polyester-polyurethane), “Sancure 815” (polyester-polyurethane), “Sancure 878” (polyether-polyurethane) and “Sancure 861” (polyether-polyurethane) by the company Sanncor, under the names “Neorez R-974” (polyester-polyurethane), “Neorez R-981” (polyester-polyurethane) and “Neorez R-970” (polyether-polyurethane) by the company ICI, and the acrylic copolymer dispersion sold under the name “Neocryl XK-90” by the company Avecia.

An embodiment of the present invention provides a recordable media constructed from any compatible light-emitting, reflective, luminescent, holographic, semi-metallic, metallic or sparkly metallic base layer or substrate that can accept at least one layer of the semi-opaque or opaque primarily organic particles and a polymeric binder ink receptive layer coating thereon, or can incorporate the ink receptive layer as a part of the composition that provides the light-emitting, reflective, luminescent, holographic, semi-metallic or metallic layer. The ink-receptive layer is a topcoat layer that may be optionally coated with a porous ink-transmitting layer, or is a composition that may be incorporate into a metallic composition, a thermoplastic composition, or both.

Another embodiment of the invention provides a micro porous photo quality printable ink receiving media for recording a light-emitting, reflective, luminescent, holographic, semi-metallic, or metallic image including a substrate basecoat or layer that is a light-emitting, reflective, luminescent, holographic, semi-metallic, or metallic image substrate base at least partially coated with the micro porous ink-receptive coating layer.

In a preferred of the present invention, the ink-receptive layer is composed primarily of an organic particle and polymeric binder, optionally further containing one or more cross-linker agents and inorganic porous pigments. Examples of organic polymeric particles are polyolefin, polyamide, and polyester particles. Preferably, substantially porous thermoplastic particles having a high surface area are used. Preferably, the ink-receptive layer is a topcoat layer for an inkjet recordable media that may be optionally further coated with another topcoat layer that is a porous ink-transmitting layer. Optional porous ink-transmitting layers also may be coated over compatible light-emitting, reflective, luminescent, holographic, semi-metallic or metallic base layers or substrate basecoat layers prior to coating of the media with one or more ink receptive layers according to the invention.

An embodiment of the invention provides such ink receptive layers wherein the crosslinkers or binders compatible with the other components of the ink receptive layer are selected from group of thermoplastic polyurethanes and its copolymers, polyesters polyamides, coploymers of polyethylene (waxes) etc. The example of useful polymers are; commercially available polyurethanes that can be heat melted to or fused with receptor surface by hand ironing or heat pressing.

Suitable thermoplastic binders include polymers and copolymers of, but are not limited to, polyurethanes, polyesters polyacrylates, polyethylenes, ethylene-acrylic acid copolymers, and ethylene-vinyl acetate copolymers. Desirably, the binders are heat-softenable at temperatures of less than or about 350° F. In one embodiment of the present invention, the surface meltable layer contains one or more film-forming binders in the form of an ethylene-acrylic acid copolymer dispersion available from Michelman, Chemical Company, Cincinnati, Ohio under the tradename MICHEM® Prime 4983; a similar ethylene-acrylic acid copolymer dispersion also available from Michelman, Chemical Company, Cincinnati, Ohio under the tradename MICHEM® Prime 4990; another ethylene-acrylic acid copolymer dispersion also available from Michelman, Chemical Company, Cincinnati, Ohio under the tradename MICHEM® Prime 4990R; or an ethylene-vinyl acetate copolymer binder available from Air Products, Allentown, Pa. under the tradename AIRFLEX® 540.

Useful polyurethanes include but not limited to are aromatic polyether polyurethanes, aliphatic polyether polyurethanes, aromatic polyester polyurethanes, aliphatic polyester polyurethanes, aromatic polycaprolactam polyurethanes, and aliphatic polycaprolactam polyurethanes. Particularly useful polyurethanes include aromatic polyether polyurethanes, aliphatic polyether polyurethanes, aromatic polyester polyurethanes, and aliphatic polyester polyurethanes.

Examples of some commercial polyurethanes include but not limited to are: Sancure 2710® and/or Avalure UR 445® (which are equivalent copolymers of polypropylene glycol, isophorone diisocyanate, and 2,2-dimethylolpropionic acid, having the International Nomenclature Cosmetic Ingredient name “PPG-17/PPG-34/IPDI/DMPA Copolymer”), Sancure 878®, Sancure 815®, Sancure 1301®, Sancure 2715®, Sancure 1828®, Sancure 2026®, Sancure 1818®, Sancure 853®, Sancure 830®, Sancure 825®, Sancure 776®, Sancure 850®, Sancure 12140®, Sancure 12619®, Sancure 835®, Sancure 843®, Sancure 898®, Sancure 899®, Sancure 1511®, Sancure 1514®, Sancure 1517®, Sancure 1591®, Sancure 2255®, Sancure 2260®, Sancure 2310®, Sancure 2725®, and Sancure 12471® (all of which are commercially available from BF Goodrich, Cleveland, Ohio), Bayhydrol DLN (commercially available from Bayer Corp., McMurray, Pa.), Bayhydrol LS-2033 (Bayer Corp.), Bayhydrol 123 (Bayer Corp.), Bayhydrol PU402A (Bayer Corp.), Bayhydrol 110 (Bayer Corp.), Witcobond W-320 (commercially available from Witco Performance Chemicals), Witcobond W-242 (Witco Performance Chemicals), Witcobond W-160 (Witco Performance Chemicals), Witcobond W-612 (Witco Performance Chemicals), Witcobond W-506 (Witco Performance Chemicals), NeoRez R-600 (a polytetramethylene ether urethane extended with isophorone diamine commercially available from Avecia, formerly Avecia Resins), NeoRez R-940 (Avecia Resins), NeoRez R-960 (Avecia Resins), NeoRez R-962 (Avecia Resins), NeoRez R-966 (Avecia Resins), NeoRez R-967 (Avecia Resins), NeoRez R-972 (Avecia Resins), NeoRez R-9409 (Avecia Resins), NeoRez R-9637 (Avecia), NeoRez R-9649 (Avecia Resins), and NeoRez R-9679 (Avecia Resins).

Some useful polyurethanes are aliphatic polyether polyurethanes. Examples of such aliphatic polyether polyurethanes include Sancure 2710® and/or Avalure UR 445®, Sancure 878®, NeoRez R-600, NeoRez R-966, NeoRez R-967, and Witcobond W-320.

In one embodiment, the thermoplastic polymeric binder comprises at least one polyester polyurethane. Examples of these polymeric core include those sold under the names “Sancure 2060” (polyester-polyurethane), “Sancure 2255” (polyester-polyurethane), “Sancure 815” (polyester-polyurethane), “Sancure 878” (polyether-polyurethane) and “Sancure 861” (polyether-polyurethane) by the company Sanncor, under the names “Neorez R-974” (polyester-polyurethane), “Neorez R-981” (polyester-polyurethane) and “Neorez R-970” (polyether-polyurethane) by the company ICI, and the acrylic copolymer dispersion sold under the name “Neocryl XK-90” by the company Avecia.

In a preferred embodiment of the invention, the binder for the ink receptive layer is selected from thermoplastic vinyl, polyurethane, polyester, polyamide, polyacrylates, polyolefins, polystyrene and their copolymers alone or in combinations, and the cross linker is selected from an azetidinium or salt cross-linker, an oxazoline derivative cross-linker, or an aziridine base or salt cross-linker.

Another embodiment of the invention utilizes the above ink receptive coating in combination with any compatible light-emitting, reflective, luminescent, holographic, semi-metallic or metallic base layer or substrate, preferably with an absorbent basecoat layer coated thereon prior to coating of the ink-receptive layer, to provide an ink recordable media, preferably an inkjet-receptive recordable media suitable for photographic or other graphic recording. A preferred basecoat layer includes a combination of an acceptable pigment and binder, and the basecoat may further include deformable particles, such as core-shell polymeric pigments.

A further embodiment of the invention provides a method for increasing the gloss, reflectivity, luminescence, metallic-looking image, or holographic-like image or surface smoothness presented by the topcoat of a printing medium by optionally including deformable particles in an underlying basecoat layer or substrate followed by calendaring of the printing medium.

A still further embodiment of the invention provides a light-emitting, reflective, luminescent, holographic, semi-metallic or metallic inkjet printing media constructed from a light-emitting, reflective, luminescent, holographic, semi-metallic or metallic base layer or substrate that is at least partially coated with the micro porous ink-receptive coating layer.

A still further embodiment of the invention provides a light-emitting, reflective, luminescent, holographic, semi-metallic or metallic inkjet printing media constructed from a light-emitting, reflective, luminescent, holographic, semi-metallic or metallic base layer or substrate that is at least partially coated with the micro porous ink-receptive coating layer.

In any of the above multilayer embodiments of the invention, the thermoplastic layer of such embodiments can comprise a support substrate that is first coated with a release layer comprising silicone. In another implementation of such embodiments, a silicone layer can be applied to the thermoplastic layer after the thermoplastic layer is formed to provide a release mechanism for such substrates. Preferably, the thermoplastic layer has a softening point in the range of from about 120 degrees centigrade to about 190 degrees centigrade, and may comprise a mixture of thermoplastic polymers that melt at different temperatures from about 50 degrees centigrade to about 190 degrees centigrade.

Examples of thermoplastic components that may comprise thermoplastic layers are suitable thermoplastic polymers having softening points as described above, such as a member selected from polyamides, polyolefins, polyesters, poly(vinyl chloride), poly(vinyl acetate), polyacrylates, acrylic acid, methacrylic acid, and copolymers and mixtures thereof. Preferably, an ethylene/acrylic acid copolymer is at least one of the thermoplastic components utilized. More preferably, ethylene/methacrylic acid or ethylene/vinyl acetate copolymer is utilized. For example, ENOREX VN 379 (an aqueous dispersion containing polymers and copolymers of acrylic acid, ethylene, methyl methacrylate, and 2-ethyl hexylacrylate, and ammonia), available from Collano Ebnother AG, can be used. MICHEM 4983 RHS (an ethylene/acrylate copolymer), available from Michelman, Inc., can be used.

Mono-layers or multiple layered substrates according to the invention may optionally include organic or inorganic pigments, that may be opaque, semi-opaque, semi-translucent, translucent, reflective, or a combination thereof. Suitable inorganic pigments include silica, alumina, titanium dioxide, zinc sulfide, zinc oxide, antimony oxide, barium sulfate, and calcium carbonate. Preferably, titanium dioxide pigment is used as a pigment when white or off-white opaque or semi-opaque layers are desired.

Also, the present invention encompasses a method for the thermoplastic application of an image to a fabric material that utilizes the above-described ink-jet printable substrate upon which has been recorded a positive or negative image and the printed substrate is thermoplastically affixed to the a fabric by apply the recorded substrate to the fabric, optionally utilizing a heat-resistant substrate protective substrate inserted between a heat source and the recorded substrate, applying sufficient heat or light sufficient to soften or partially melt the thermoplastic layer and thereby affix the recorded substrate to the fabric. In one embodiment, the method comprises the steps of: 1) printing an image on the coated layers with an ink-jet printer, 2) removing the support paper from the imaged coating layers, 3) placing the imaged coating layers on a fabric material, 4) placing a protective substrate (e.g., a silicone-coated opaque or transparent substrate) over the imaged coating layers on the fabric material, and 5) ironing the protective paper, whereby the image is transferred to the fabric.

In one preferred alternative embodiment of the method for applying such a substrate to a fabric, the protective substrate applied over the recorded substrate comprises at least one component that is receptive to a wavelength of light, such as a laser, which can generate sufficient heat upon the application of light of a particular wavelength of light whereby the thermoplastic layer can be softened or partially melted by heat transfer to the thermoplastic layer. In one such preferred embodiment, a clear glass, plastic or other light transmitting layer is applied with pressure to the protective layer in order to hold the recorded substrate against the fabric as it is applied. The protective layer may be omitted, if the thermoplastic layer can be cured with light or radiation through such a pressure holding device.

One or more of the coating layers on the image recordable substrate may contain additives such as optional surface active agents that control the wetting or flow behavior of the coating solutions, antistatic agents, suspending agents, antifoam agents, acidic compounds to control pH, optical brighteners, UV blockers/stabilizers, and the like. Conventional coating techniques can be used to apply layers to the substrate. For example, roller, blade, wire bar, dip, solution-extrusion, air-knife, and gravure coating techniques can be used. Typically, the total weight of the coating layers is in the range of 10 to 100 grams per square meter (gsm) and preferably 15 to 60 gsm. Coating layers may be dried in a conventional oven, laser cured, radiation cured, or a combination thereof.

Preferably, the image is heat-transferred to the fabric using an ordinary household iron. A preferred method involves the following steps: peeling a support substrate from the imaged coatings so that the imaged coatings remain as a film-like material; placing the imaged coatings (film-like material) on the fabric so that the image faces-up (i.e., the image is exposed; it is not face-down against the fabric); placing a sheet of protective substrate over the image; hand-ironing the protective substrate so that the imaged coatings are pressed into the fabric and the image is transferred to the fabric; and removing the protective paper after cooling. In one embodiment, the support substrate that is removed from the image recorded substrate has the dual purpose of also being a single use protective substrate that may be placed over the recorded image substrate and heat applied through it to affix the imaged substrate to the fabric.

The protective substrate, as described above, is preferably a stick-resistant transparent paper, e.g., a transparent or substantially transparent silicone-coated tissue paper. A person can easily remove such papers from the fabric after the ironing step. Optionally, the dual function support substrate that peeled away from the imaged coatings is used as the protective paper for the heat application step that affixes the imaged substrate to the fabric. The peeled-off support substrate should be a single use substrate to avoid certain deficiencies such as, among other deficiencies, it may curl up along its edges during the ironing step. The protective paper should always preferably be a fresh sheet. Transparent protective substrates offer several advantages over opaque substrates. Particularly, if a transparent substrate is used, the person applying heat to the protective substrate can better observe the image as it is transferred to the fabric, and he or she can avoid under or over-heating the fabric. If too little heat is applied, the image does not completely transfer and the image may peel away from the fabric. If too much heat is applied, burn marks may appear on the image and fabric

@@@

The invention provides a light-emitting, reflective, luminescent, holographic, semi-metallic, or metallic imaged or imageable media for applying to a textile, fabric or canvas receptor element having at least one surface with valleys or pores, or having at least one surface that is substantially smooth or textured, that can be adhered to by the imaged or imageable media, wherein the receptor element may be a flexible, semi-rigid or rigid textile, fabric, or canvas element, and wherein:

(i) the media includes a transfer sheet comprising a support having a first surface and a second surface and having at least one printable ink receiving media on the first surface, second surface, or both for recording a positive or negative light-emitting, reflective, luminescent, holographic, semi-metallic, or metallic image wherein the transfer sheet comprises a light-emitting, reflective, luminescent, holographic, semi-metallic or metallic substrate coated with a semi-opaque or opaque primarily organic, primarily inorganic or mixed organic and inorganic ink-receptive layer that remains opaque or is rendered semi-translucent or translucent upon recording of an ink image, upon curing of the media after imaging or both, and the ink receptive layer includes or is part of a coating capable of receiving an image on the first or second surface of the support, or alternatively the light-emitting, reflective, luminescent, holographic, semi-metallic or metallic substrate is imbedded or dispersed within an ink-receptive layer that is rendered semi-translucent or translucent upon recording of an ink image, upon application of heat, light or catalyzed curing, or both

(ii) the media comprises at least one printable ink receiving surface with a positive, a negative image, or both

(iii) the media optionally comprises a release sheet that may be removed or dry peeled from the media support in the absence of wet release prior to hand ironing, prior to using a heat press process, or prior to applying a light, heat or chemical catalyzed adhesive curing method after the when the image, or optionally the media comprises a removable layer that can be removed by dry peeling after heat pressing or otherwise curing,

(iv) the media comprises at least one surface that will adhere or can be made to adhere to a receptor element having a surface that is visually smooth or textured, and may contain valleys or pores,

(v) the media surface according to (iv) can optionally be covered by a non-stick prior to completion of manual or machine heat pressing or prior to applying a light or chemical catalyzed adhesive method and apply pressure, and

(vi) the non-stick cover sheet sheet can be heat pressed to drive the dry peeled coating into the receptor element having valleys or pores, or force applied to it prior to ar during application of a light, heat or chemical adhesive method to adhere the imaged or imageable media to the element.

The embodiment as described above, which can be applied to a textile, fabric or canvas receptor element article by use of a hand-held heat transfer device that is available to an ordinary consumer or can be affixed to already manufactured textile, fabric or canvas receptor elements by applying one or more of heat, light or chemical catalyzed adhesive methods to the imaged light-emitting, reflective, luminescent, holographic, semi-metallic, sparkling metallic or metallic image, wherein the imaged media comprises:

(i) a transfer sheet comprising a support (such as a release paper) having a first surface and a second surface and having an imaged printable ink-jet or silk screen image receiving layer for recording a positive or negative light-emitting, reflective, luminescent, holographic, semi-metallic, or metallic image wherein the imaged media comprises a light-emitting, reflective, luminescent, holographic, semi-metallic, sparkling or metallic substrate coated with a semi-opaque or opaque coating, primarily comprised of organic particles and thermoplastic polymers and optionally containing inorganic pigment containing organic particles, ink-receptive layer that is rendered opaque to translucent upon recording of an ink image thereon or therein, and a coating capable of receiving an image on the first or second surface of the support,

(ii) the imaged media comprises a positive or negative digital image that was created upon the media by using an inkjet printer, and

(iii) the imaged media optionally comprises a dry peeling coating or a wet release coating that may be removed prior to hand ironing or before applying a light or chemical catalyzed adhesive method when the image is a positive, or may be optionally dry peeled after heat pressing if the image is a negative image.

The above media, in one embodiment comprises an ink jet or silk screen printable substrate having from at least two layers, and further comprises:

(a) a thermoplastic transfer substrate layer over a release paper or a similar type peel off transfer backing covered by a reflective metallic powder or metallic flakes, metallic layer or other metallic coating, or alternatively, metallic particles may be incorporated into the thermoplastic transfer substrate layer of the media, and

(b) an inkjet receptive coating, layer or laminate covers the curable or non curable thermoplastic layer comprising thermoplastic organic particles, and optionally comprising inorganic pigments other ink receptive polymers as binder, cross linkers, and additives such as surfactants, dispersing agent, plasticizers, and other acceptable functional and non-functional additives.

The media as described above, in further embodiment provides a media as described above, wherein the thermoplastic substrate layer comprises a pluralistic single layer upon a peel-off transfer backing, and wherein the thermoplastic substrate layer further comprises the metallic powder or metallic flakes in combination with ink receptive components and comprise a single layer that can be produced by one or more coatings of a single layer composition upon a removable transfer backing.

In one embodiment, the comprises an inkjet or silk screen printable substrate that has three layers formed upon a peel-off removable backing, wherein the layer next to the peel-off backing is an element adhering layer that is (i) a thermoplastic layer, which can be softened with the heat from a regular fabric ironing device, or (ii) is a light, chemical or heat adhering layer that comprises a light, heat or chemical curable composition, and the top layer is a porous ink jet or silk screen printable layer, and wherein at least one layer located substantially in between the ink jet or silk screen printable layer and the adhering layer is a metallic layer that is formed by applying a curable or dryable solution that is a liquid or gel and the liquid or gel comprises metallic power, flakes or metallic-like reflective particles, applying metallic particles by metallic sputtering, or applying a metallic laminate layer that may or may not contain a thermoplastic binder. The media may comprise a single or multilayer printable substrate that does not require a peel-off backing and may be appended to a fabric by utilizing the heat of a normal iron or a similar heating process, wherein one surface comprises a thermoplastic layer that is also constructed as an inkjet receptive layer that permits the printing of a positive or negative image upon the thermoplastic surface that will be visible as a positive image once the substrate has been applied to the fabric, and the surface where the positive image may be view may be translucent, semi-translucent, or semi-opaque.

In a further embodiment, the above media can comprise a sealing coating, a protective coating, or both that are applied to the printed media after the printed media is affixed to a textile, fabric or canvas.

In yet another embodiment, the invention provides a kit for applying a media substrate as described above that is adapted for affixing to a textile, canvas or fabric sheet or article that is smooth or textured and may comprise valleys or pores by a heat transfer method, wherein the kit comprises at least one media substrate according to claim one that is already imaged or may be imaged by an inkjet printing or silk screen procedure, and at least one protective heat transfer sheet that can be applied between at least one surface of the media and a hand held heat device while the media substrate is being affixed to a textile, canvas or fabric sheet to avoid damaging or smudging the imaged substrate, and may optionally contain a container or article for applying a protective coating to the imaged media after it has been applied to the textile, canvas or fabric sheet or article.

Preferably, the kit embodiment of the invention comprises a media substrate that may be affixed to a textile, canvas or fabric sheet or article by utilizing a hand-held heat transfer device that is available to an ordinary consumer to modify already manufactured textile, canvas or fabric sheet or article of commerce by applying the a light-emitting, reflective, luminescent, holographic, semi-metallic, sparkling metallic or metallic image to the textile, canvas or fabric sheet or article receptor element.

The kit according to the invention, wherein the kit is adapted for a receptor element having valleys or pores further comprises at least one transfer sheet medium comprising a support or release paper having a first surface and a second surface and having printable ink or silk screen image receiving layer for recording a positive or negative light-emitting, reflective, luminescent, holographic, semi-metallic, or metallic image wherein the imaged media comprises a light-emitting, reflective, luminescent, holographic, semi-metallic, sparkling or metallic substrate coated with a semi-opaque or opaque coating, primarily comprised of organic particles and thermoplastic polymers and optionally containing inorganic pigment containing organic particles, ink-receptive layer that is rendered opaque to translucent upon recording of an ink image thereon or therein, and a coating capable of receiving an image on the first or second surface of the support and the coating may be imaged with a positive or negative digital image using a printer or silk screen process, and the coating can be dry peeled from the support in the absence of wet release prior to hand ironing.

In addition, the kit for applying a media substrate as described above is adapted for affixing to a textile, canvas or fabric sheet or article that is smooth or textured and may comprise valleys or pores by a light or chemical adhesive method, wherein the kit comprises at least one media substrate according to claim one that is already imaged or may be imaged by an inkjet printing or silk screen procedure, and at least one protective heat transfer sheet that can be applied between at least one surface of the media and during at least part of the time that a light or chemical adhesive method is being applied to the media substrate to affix it to a textile, canvas or fabric sheet to avoid damaging or smudging the imaged substrate, and may optionally contain a container or article for applying a protective coating to the imaged media after it has been applied to the textile, canvas or fabric sheet or article.

In another embodiment, the ink printable or silkscreen printable light-emitting, reflective, luminescent, holographic, semi-metallic, or metallic imaged or imageable substrate as described above according to the invention is a substrate that may be applied to a textile, canvas or fabric sheet or article, which is smooth or textured and may comprise valleys or pores by a heat transfer process, comprising a micro porous photo quality printable ink receiving media layer located upon a thermoplastic heat transferable substrate, or incorporated within a thermoplastic layer of the thermoplastic heat transferable substrate for recording a light-emitting, reflective, luminescent, holographic, semi-metallic, metallic or sparkly metallic image comprising a light-emitting, reflective, luminescent, holographic, semi-metallic or metallic substrate coated with a semi-opaque or opaque coating predominantly containing organic particles and ink-reactive polymer binders to provide an ink-receptive layer that is rendered semi-translucent or translucent upon recording of an ink image, wherein the ink-receptive layer comprises polymeric organic particles, polymer binders and other additives such as surfactant and dispersing agent. Optionally, the ink printable or silkscreen printable substrate may contain inorganic pigments within or upon the ink receptive layer.

Acceptable organic polymeric particles for the ink printable or silk screen printable substrate are polyolefin, polyamide, polyacrylates, polyvinyls and polyester or their copolymer particles and may optionally further include one or more, cross-linker agents and inorganic porous pigments. Preferably, the organic particles comprise substantially porous thermoplastic particles having a high surface area to better absorb water and water-miscible solvents that are often contained in aqueous-based inks, wherein the particles may have a particle size distribution containing particles with a diameter size in the range of 1 μm to 200 μm.

In a preferred embodiment, the ink receptive layer of the ink printable or silk screen printable substrate comprises at least one polyurethane, polyacylate, polyolefins and polyvinyls and its copolymer, or polyester binder that is capable of binding porous organic polymeric particles and the ink-receptive layer is capable of absorbing aqueous-based inks from an inkjet printer to form an image, and may optionally include crosslinkers or binders compatible with the other components of the ink receptive layer that are selected from group of thermoplastic polyurethanes, polyesters polyamides, copolymers of polyethylene, polyethylene waxes, including commercially available polyurethanes or polyesters or their copolymers that can be heat melted or fused with receptor surface by hand ironing or heat pressing. Also, when the inks used in the ink-jet printing devices are aqueous-based inks containing molecular dyes or pigmented colorants wherein water is a major component and the aqueous-based inks may further include amounts of water-miscible solvents such as glycols and glycol ethers.

The ink printable or silk screen printable substrate as described herein may comprise a thermoplastic substrate layer that is formed as a pluralistic single layer upon a peel-off transfer backing, wherein either or both of the thermoplastic and ink receptive substrate layers further comprise metallic powder, metallic flakes, or another metallic like-reflective components to produce a two layer or single layer with a removable transfer backing.

The invention also provides a process of recording an image on the recording medium according to the invention, comprising the step of using a writing instrument or machine. Preferably, the writing instrument or machine is an ink-jet printer or ink-jet printing press, but silk screening or any other similar process may be utilized.

### Acceptable Substrates for Use in the Invention

A preferred recording medium of the invention is an ink-jet recording medium wherein the recording medium is a substrate comprising a inkjet printable and recordable layer, a thermoplastic layer, and a peel off backing. Alternatively, two or more of these substrate layer aspects may be consolidated and comprised by a single layer to provide a recordable substrate for applying to a fabric. The outermost surface may optionally comprise a protective layer when an image can be recorded from the bottom surface of the substrate as a negative image, or a protective layer may be optionally be applied after the image is recorded, after the substrate is affixed to the fabric, or both. As described herein, the peel off layer or the layer next to the peel off layer may be an image recordable layer, and a negative image can be applied, such that the positive image of the recorded negative image can ultimately be viewed as a positive image from the “face-out” side of the substrate.

In one preferred embodiment of the invention, a large number of widely varying types of substrates can be utilized that provide at least one light-emitting reflective, metallic, or luminescent surface for the image recordable substrate. Such substrates may be comprised of a material that inherently provides a light-emitting, reflective, metallic, or luminescent surface, or may be comprised of a substrate that does not have such characteristics if it can be coated or treated with a light-emitting, reflective, metallic, or luminescent material to provide the desired surface. Such substrates may be flexible or rigid, porous or nonporous, cellulosic or non-cellulosic.

Non-limiting examples of substrate layers suitable for use with the present invention include resin coated or uncoated paper, textiles, polymeric substrates, inorganic substrates, metallic sheets, metallized polymer sheets, laminates, foil laminated polymer sheets, sheets upon which metal or metal like particles have be applied by processes such as by metallic sputtering, substrates to which a gel or liquid curable metallic-like layer has been applied, and the like. Specific suitable substrates examples are: polymeric films, sheets, coatings, and solid blocks, comprised of, for example, polyesters (including “MYLAR®” flexible film), vinyl polymers, polysulfones, polyurethanes, polyacrylates, polyimides, or the like; metallic films, sheets, coatings, foils and solid blocks, comprised of, for example, aluminum, brass, copper, or the like; inorganic substrates in the form of films, sheets, coatings, objects, and solid blocks, comprised, of, for example, glass, metal oxides, silicon-containing ceramics, and the like; textiles having a reflective or luminescent surface; and laminates such as a paper/polymeric film, polymeric film/metal foil laminate, or paper/metal foil laminate. The nature of a substrate is not critical, but a preferred class of substrates are those having at least one light emitting, reflective, holographic, metallic, or luminescent surface that can be used in the invention to produce a reflective, holographic, light emitting, luminescent or metallic-looking image when contacted with a recording liquid followed by heat or radiation transfer on surfaces with valleys and pores such as textile, but not limited to it, in one or more steps.

If a substrate that is not itself, light-emitting, reflective, holographic, metallic, or luminescent is used in the invention it may optionally be treated to provide a light-emitting, reflective, holographic, metallic, or luminescent surface. For example, a layer of a metallic foil or reflective polymeric film can be laminated to the substrate, or the substrate surface may be coated or treated with reflective or luminescent materials, for example, luminescent dyes selected from the dye families of fluorescein dyes, rhodamine dyes, pyrene dyes and porphyrin dyes.

In one embodiment of the invention, a preferred substrate comprises a paper/foil laminate or a polymer film that has been metallized by sputtering or by some other thin-layer metallizing or coating processes. The paper layer of the laminate may be formed from any convenient type of printing paper stock of desired weight, and may be in the form of a flat or sheet structure of variable dimensions. The term “paper”, as used in this context, is meant to encompass printing paper (e.g., inkjet printing or conventional printing paper such as gravure, litho, etc.), writing paper, drawing paper, and the like, as well as board materials such as cardboard, poster board, Bristol board, and the like. Many such paper compositions are well known and various types of additives which can be incorporated into paper for different purposes are also well known and widely described; see for instance, Blair (ed.), The Lithographers Manual, (7th Edn.: 1983), Chapter 13, Sections 8 and 9.

Methods for preparing a paper/metal foil laminate are well-known, and well-described in the art. Also, commercial paper/foil laminates are available in a range of thicknesses and weights, such that foil papers with any desired degree of flexibility or stiffness can be selected. Those skilled in the art will be readily able to select the appropriate type of paper, foil or paper/foil laminate for use with the desired type and weight of final product to be produced.

In one preferred embodiment, the inkjet recording medium comprises a substrate as described above that may be flexible or rigid, porous or nonporous, cellulosic or non-cellulosic and is coated with at least one predominantly inorganic micro porous ink receptive layer. The inkjet recording medium of the present invention may comprise a substrate wherein one or more functional or non-functional coating layers are placed between the substrate and the at least one micro porous ink receptive layer, or over the at least one micro porous ink receptive layer.

### Acceptable Binders for Use in the Invention

In addition to the binders mentioned above for use in the coating layers on in the substrate layers, ancillary polysaccharide binders or ancillary resin binders may be utilized. Examples of such ancillary binders are as follows.

### A. Ancillary Polysaccharide Binders

Starches represent one category of suitable film-forming binders. Suitable starches may be any of a variety of natural, converted, and synthetically modified starches which may be or may not be thermoplastics. Examples of such starches include: starch (e.g., SLS-280 (St. Lawrence Starch)), cationic starches (e.g., Cato-72 (National Starch), hydroxyalkylstarch, wherein the alkyl has at least one carbon atom and wherein the number of carbon atoms is such that the material is water soluble, preferably from about 1 to about 10 carbon atoms, such as methyl, ethyl, propyl, butyl, or the like (e.g., hydroxypropyl starch #02382 (PolySciences, Inc.), hydroxyethyl starch #06733 (PolySciences, Inc.), Penford Gum 270 and 280 (Penford), and Film-Kote (National Starch)), starch blends (see, e.g., U.S. Pat. No. 4,872,951, describing a blend of cationic starch and starch treated with an alkyl or alkenyl succinic anhydride (ASA), preferably 1-octenyl succinic anhydride (OSA)), and the like. Such film-forming binder can also be synthetically produced polysaccharides, such as a cationic polysaccharide esterified by a dicarboxylic acid anhydride (see, e.g., U.S. Pat. No. 5,647,898). Additional saccharide binders include cellulosic materials such as alkyl celluloses, aryl celluloses, hydroxy alkyl celluloses, alkyl hydroxy alkyl celluloses, hydroxy alkyl celluloses, dihydroxyalkyl cellulose, dihydroxyalkyl cellulose, hydroxy alkyl hydroxy alkyl cellulose, halodeoxycellulose, amino deoxycellulose, dialkylammonium halide hydroxy alkyl cellulose, hydroxyalkyl trialkyl ammonium halide hydroxyalkyl cellulose, dialkyl amino alkyl cellulose, carboxy alkyl cellulose salts, cellulose sulfate salts, carboxyalkylhydroxyalkyl cellulose and the like). Still additional film-forming binders of this type include dextran (e.g., dialkyl aminoalkyl dextran, amino dextran, and the like), carrageenan, Karaya gum, xanthan, guar and guar derivatives, (e.g., carboxyalkyl hydroxyalkyl guar, cationic guar, and the like), and gelatin.

### B. Ancillary Resin Binders

Ancillary resin binders may be or may not be thermoplastic in nature. Additional film-forming binders are resins (e.g., such as formaldehyde resins such as melamine-formaldehyde resin, urea-formaldehyde resin, alkylated urea-formaldehyde resin, and the like), ionic polymers (e.g., poly(2-acrylamide-2-methyl propane sulfonic acid, poly(N,N-dimethyl-3,5-dimethylene piperidinium chloride, poly(methylene-guanidine), and the like), maleic anhydride and maleic acid-containing polymers (e.g., styrene-maleic anhydride copolymers, vinyl alkyl ether-maleic anhydride copolymers, alkylene-maleic anhydride copolymers, butadiene-maleic acid copolymers, vinylalkylether-maleic acid copolymers, alkyl vinyl ether-maleic acid esters, and the like), acrylamide-containing polymers (e.g., poly(acrylamide), acrylamide-acrylic acid copolymers, poly(N,N-dimethyl acrylamide), and the like), poly(alkylene imine)-containing polymers (e.g., poly(ethylene imine), poly(ethylene imine) epichlorohydrin, alkoxylated poly(ethylene imine), and the like), polyoxyalkylene polymers (e.g., poly(oxymethylene), poly(oxyethylene), poly(ethylene oxide), ethylene oxide/propylene oxide copolymers, ethylene oxide/2-hydroxyethyl methacrylate/ethylene oxide and ethylene oxide/hydroxypropyl methacrylate/ethyleneoxide triblock copolymers, ethylene oxide-4-vinyl pyridine/ethylene oxide triblock copolymers, ethylene oxide-isoprene/ethylene oxide triblock copolymers, epichlorohydrin-ethylene oxide copolymer, and the like), etc.

### Forming Layers on the Recording Medium

The compositions corresponding to micro porous ink-receptive, porous under or over layers, or basecoat layers may be applied to any acceptable light-emitting, reflective, luminescent, holographic, semi-metallic or metallic base coat layer or substrate in any conventional manner, for example, by using a Meyer rod, slot die, roller, knife, dipping, painting, spraying, etc. Generally, coating is accomplished by dip coating, reverse roll coating, extrusion coating, rod coating or the like. If the substrate is a paper or thin polymeric film and the coating composition is applied on-machine, in order to achieve acceptable manufacture speeds of about 20 to 1000 feet per minute, preferably 30-1000 feet per minute, it is recommended that the weight of the substrate, e.g., sized paper, be greater than about 30 grams per square meter.

The coating compositions according to the invention can be readily prepared from commercially available starting materials and/or reagents, are compatible with additional binders or additives, can be used with a variety of substrates, are compatible with a variety of printing methods, including conventional and digital printing methods (particularly ink-jet printing, including drop-on-demand printing and continuous printing), and can also be used with existing commercial manufacturing methods and equipment, including, for example, paper production processes and equipment.

The selection of ancillary or optional ingredients for each of coating agents to create the layers described above, including the ink-receptive layer coating agent in the present coating compositions may be varied according to a variety of factors such as the nature of the substrate to be treated, the colorant to be used in printing on the treated substrate, etc. The relative ratios of ingredients within the mixture will also vary according to such factors, but typically the ratios of primary ingredients are described as above, and are varied by the inclusion of ancillary or optional ingredients to create more durable coatings for a particular substrate.

In general, the pH of the ink-receptive layer coating composition is generally in the range of about 2-12, preferably at least about 2-7.5. An acidic to neutral pH is preferred when dyes or inks are neutral to basic, and a neutral to basic pH is preferred when an acidic to neutral pH dye or ink. The pH of the ink-receptive layer coating can be maintained or varied for a particular substrate by adding pH adjusters or stabilizers such as appropriate bases from ammonia, primary, secondary, and tertiary alkyl amines, ethanolamines, diamines, and the like.

### Additional Components for Coating Layers

Additional components may be present in each of the coating composition utilized for ink-receptive layers or other substrate coating layers. Non-limiting examples of such additional components are inorganic fillers, anti-curl agents, surfactants, plasticizers, humectants, UV absorbers, optical brighteners, light fastness enhancers, polymeric dispersants, dye mordants and leveling agents. Such additional components and their use are commonly known in the art. Preferred additives are optical brighteners, which generally represents approximately 0.0 wt. % to 2.0 wt. % of a coating composition after drying on a substrate. Illustrative examples of such additives are provided in U.S. Pat. Nos. 5,279,885 and 5,537,137. The coating compositions may also include one or more crosslinking agents selected from the group consisting of zirconium acetate, ammonium zirconium carbonate, or the like, for intramolecular and/or intermolecular crosslinking of coating agents, and/or a chelating agent such as boric acid. Colorants e.g., pigments, dyes, or other colorants, may also be present in the opaque coating composition.

### Preparation of the Coating Compositions

While the coating compositions can each be prepared in an organic solvent, it is preferably provided in an aqueous liquid vehicle wherein small amounts of a water-soluble organic solvent may be present. The aqueous liquid vehicle will generally be water, although other inorganic compounds which are either water-soluble or water miscible may be included as well. Thermoplastic layer over bases substrate can also be applied by extrusion of thermoplastic compositions of layers where no organic or inorganic solvent is present or is less than 10% bon weight basis.

On occasion it may be necessary, or desired, to add a solubilizing compound during preparation of the coating composition so that the components dissolve or disperse in the aqueous liquid vehicle, e.g., an inorganic base such as ammonia and/or an organic amine. Suitable organic amines include lower alkyl-substituted amines such as methylamine, dimethylamine, ethylamine, and trimethylamine, as well as ethanolamine, diethanolamine, triethanolamine, and substituted ethanolamines, typically lower alkyl-substituted ethanolamines such as N-methyl and N,N-dimethyl ethanolamines, and morpholine. Such compounds are also useful for bringing the pH into the desired range for basic formulations as discussed above, and, if present, will generally represent not more than about 20 wt. % of the composition, and in most cases will represent not more than about 10 wt. % of the composition.

### Image Formation

The recording medium according to the invention, preferably an ink-jet recording medium, is contacted with an ink or other solution to form an image on the medium. In one preferred embodiment, an image forming step is employed that involves applying an aqueous or solvent based ink to obtain desired image or background colors and thereby form a mat, glossy, or semi-glossy image. An image forming step may employ any of a variety of well-known machine or process printing techniques, such as inkjet printing, laserjet printing, flexographic printing, gravure printing and the like. In another embodiment, the image forming step may employ a writing instrument such as a pen, marker, gel pen, rollerball pen, ballpoint pen, and the like. In general, the image forming process involves applying a recording liquid in a desired image pattern to the ink-jet recording medium or other coated substrate of the invention.

Many inkjet printing processes may be utilized to form an image on the ink-jet recording medium of the invention that are well known in the art, e.g., U.S. Pat. Nos. 4,601,777; 4,251,824; 4,410,899; 4,412,224; and 4,532,530. Also, thermal ink transfer printers may be utilized, which apply an image to a substrate by a dye sublimation process, to also form mat, glossy, or semi-glossy looking images. Hot melt type inkjet printers, such as Tektronix ink jet printers that use inks formed of low melting solids are also suitable. In addition, recorded medium images can also be produced using a wide variety of other printing and imaging processes, such as offset printing, printing with pen plotters, drawing, handwriting, painting with ink pens, brush stenciling, spray painting, and the like.

In one embodiment of the invention, inks are used in the formation of the image on the ink-jet recording medium or other substrates of the invention. Such an ink may be any suitable ink containing a colorant, e.g., a pigment, dye, or stain, having one or more reactive groups suitable for reacting, either covalently or ionically, with a colorant-reactive component of the opaque coating agent present on the treated substrate. Additionally, aqueous and solvent-based, dye sublimation, or hot melt inks can be utilized with the ink-jet recording medium of the invention, or other coated substrates. The particular selection of the specific ink and colorant can vary with the colorant-reactive component of the image-enhancing agent. Thus, preferred colorants for use in forming an image on a substrate treated with the present image-enhancing compositions are those containing one or more ionizable, nucleophilic or otherwise reactive moieties.

Particularly preferred colorants contained in the inks useful with the invention are thus dyes containing acidic groups (e.g., carboxylate, phosphonate, sulfonate or thiosulfonate moieties), basic groups (e.g., unsubstituted amines or amines substituted with 1 or 2 alkyl, typically lower alkyl, groups), and/or nucleophilic or otherwise reactive moieties (e.g., hydroxyl, sulfhydryl, cyano or halo).

Selection of a particular ink for recording an image upon the substrates or recording medium of the invention depends upon the requirements of a specific application, such as desired surface tension, viscosity, drying time, and the like. If an aqueous ink is selected, the aqueous liquid vehicle of inks suitable for use in the invention will generally be water, although other non-organic compounds which are either water-soluble or water miscible may be included as well. A water soluble organic vehicle such as an alcohol may also be used in such inks. The colorant may be dissolved, dispersed or suspended in the aqueous liquid (or other polar vehicle), and is present in an amount effective to provide the dried ink with the desired color and color intensity.

As mentioned above, a can also be contained in a carrier medium composed of ink and a water-soluble organic solvent. For applications utilizing such a carrier medium, representative solvents include polyols such as polyethylene alcohol, diethylene glycol, propylene glycol, and the like. Additional solvents are simple alcohols such as ethanol, isopropanol and benzyl alcohol, and glycol ethers, e.g., ethylene glycol monomethyl ether, diethylene glycol monoethyl ether. Representative examples of water-soluble organic solvents are described in U.S. Pat. No. 5,085,698 and U.S. Pat. No. 5,441,561.

Non-limiting examples of suitable water soluble organic solvents for inks that may be utilized to record an image on the recording media according to the invention, are not limited to, C₁₋₅-alkanols, e.g. methanol, ethanol, n-propanol, isopropanol, n-butanol, sec-butanol, tert-butanol and isobutanol; amides, e.g., dimethylformamide and dimethylacetamide; ketones and ketone alcohols, e.g., acetone and diacetone alcohol; C₂₋₄-ethers, e.g. tetrahydrofuran and dioxane; alkylene glycols or thioglycols containing a C₂-C₆ alkylene group, e.g., ethylene glycol, propylene glycol, butylene glycol, pentylene glycol and hexylene glycol; poly(alkylene-glycol)s and poly(alkylene-thioglycol)s, e.g., diethylene glycol, thiodiglycol, polyethylene glycol and polypropylene glycol; polyols, e.g., glycerol and 1,2,6-hexanetriol; lower alkyl glycol and polyglycol ethers, e.g., 2-methoxyethanol, 2-(2-methoxyethoxy)ethanol, 2-(2-ethoxyethoxy)-thanol, 2-(2-butoxyethoxy)ethanol, 3-butoxypropan-1-ol, -[2-(2-methoxyethoxy)-eth-oxy]ethanol, 2-[2-(2-ethoxyethoxy)ethoxy]-ethanol; cyclic esters and cyclic amides, e.g., optionally substituted pyrollidones; sulpholane; and mixtures containing two or more of the aforementioned water soluble organic solvents. Water insoluble organic solvents may also be used. Suitable water insoluble organic solvents include, but are not limited to, aromatic hydrocarbons, e.g., toluene, xylene, naphthalene, tetrahydronaphthalene and methyl naphthalene; chlorinated aromatic hydrocarbons, e.g., chlorobenzene, fluorobenzene, chloronaphthalene and bromonaphthalene; esters, e.g., butyl acetate, ethyl acetate, methyl benzoate, ethyl benzoate, benzyl benzoate, butyl benzoate, phenylethyl acetate, butyl lactate, benzyl lactate, diethyleneglycol dipropionate, dimethyl phthalate, diethyl phthalate, dibutyl phthalate, di(2-ethylhexyl)phthalate; alcohols having six or more carbon atoms, e.g. hexanol, octanol, benzyl alcohol, phenyl ethanol, phenoxy ethanol, phenoxy propanol and phenoxy butanol; ethers having at least 5 carbon atoms, preferably C.sub.5-14 ethers, e.g. anisole and phenetole; nitrocellulose, cellulose ether, cellulose acetate; low odor petroleum distillates; turpentine; white spirits; naphtha; isopropylbiphenyl; terpene; vegetable oil; mineral oil; essential oil; and natural oil; and mixtures of any two or more thereof.

Specific non-limiting examples of suitable colorants are: Dispersol Blue Grains (Zeneca, Inc.), Duasyn Acid Blue (Hoechst Celanese), Duasyn Direct Turquoise Blue (Hoechst Celanese), Phthalocyanine blue (C.I. 74160), Diane blue (C.I. 21180), Pro-jet Cyan 1 (Zeneca, Inc.), Pro-jet Fast Cyan 2 (Zeneca, Inc.), Milori blue (an inorganic pigment equivalent to ultramarine) as cyan colorants; Dispersol Red D-B Grains (Zeneca, Inc.), Brilliant carmine 6B (C.I. 15850), Pro-jet magenta 1 (Zeneca, Inc.), Pro-jet Fast magenta 2 (Zeneca, Inc.), Brilliant Red F3B-SF (Hoechst Celanese), Red 3B-SF (Hoechst Celanese), Acid Rhodamine (Hoechst Celanese), Quinacridone magenta (C.I. Pigment Red 122) and Thioindigo magenta (C.I. 73310) as magenta colorants; Dispersol Yellow D-7G 200 Grains (Zeneca, Inc.), Brilliant yellow (Hoechst Celanese), Pro-jet yellow 1 (Zeneca, Inc.), Pro-jet Fast Yellow 2 (Zeneca, Inc.), benzidine yellow (C.I. 21090 and C.I. 21100) and Hansa Yellow (C.I. 11680) as yellow colorants; organic dyes; and black materials such as carbon black, charcoal and other forms of finely divided carbon, iron oxide, zinc oxide, titanium dioxide, and the like. Specific and preferred black colorants include Acid Black 48 (Aldrich), Direct Black 58756 A (Crompton & Knowles), BPI Molecular Catalytic Gray (Brain Power), Fasday Cool Gray (Hunter Delator), Dispersol Navy XF Grains (Zeneca, Inc.), Dispersol Black CR-N Grains (Zeneca, Inc.), Dispersol Black XF Grains (Zeneca, Inc.), Disperse Black (BASF), Color Black FWI 8 (Degussa), Color Black FW200 (Degussa), Hostafine Black TS (Hoechst Celanese), Hostafine Black T (Hoechst Celanese), Duasyn Direct Black (Hoechst Celanese), Pro-jet Black 1 (Zeneca, Inc.) and Pro-jet Fast Black 2 (Zeneca, Inc.). Other suitable colorants are disclosed in U.S. Pat. Nos. 4,761,180, 4,836,851, 4,994,110 and 5,098,474.

In an additional aspect of the invention light-emitting, reflective, luminescent, holographic, semi-metallic or metallic looking images can be produced by having an image or color scheme printed on the substrate prior to its being coating with one or more layers according to the invention. In such a case, images can be generated by contacting a coated substrate with an image forming or developing solution that may optionally contain a dye or colorant, as discussed above.

In addition to the formation of the above image, there is a need to have a workable method for effecting the composition of a transfer article and a receptor element, which is a textile article of commerce. Such methodology is described in U.S. Pat. No. 6,916,589 issued Jul. 12, 2005 to Hare, et al., and is incorporated herein entirely by reference thereto.

Specifically, all patents, patent applications, journal articles and other references mentioned herein are incorporated by reference in their entireties.

To better illustrate the invention in a non-limiting manner, provided below are non-limiting illustrative examples of the invention.

### Example 1

The following media was prepared in three layers as described in the above specification.

Hot Melt Layer

| | |
|---|---|
| Polyester P-600 (Twill USA) | 100% |

Metallic Layer

| | |
|---|---|
| Michem 4983-40 R (Michelman Inc.) | 60% |
| Silbercote Aq 3130-Fix (Silberline Inc.) | 40% |

Ink receiving layer

| | |
|---|---|
| Witcobond W-213 (Chemtura Inc.) | 40% |
| Polycup 172 (Hercules Inc.) | 11% |
| Orgasol 3105 (Arkema Inc.) | 12% |
| IPA/water (1:1) | 37% |

### Example 2

The following media was prepared in three layers as described in the above specification.

Hot Melt Layer

| | |
|---|---|
| Polyurethane P-710 (Twill USA) | 100% |

Metallic Layer

| | |
|---|---|
| Michem 4983-40 R (Michelman Inc.) | 60% |
| Silbercote Aq 3130-Fix (Silberline Inc.) | 40% |

Ink receiving layer

| | |
|---|---|
| Witcobond W-213 (Chemtura Inc.) | 40% |
| Polycup 172 (Hercules inc.) | 11% |
| Orgasol 3105 (Arkema Inc.) | 12% |
| IPA/water (1:1) | 37% |

### Example 3

The following media was prepared in three layers as described in the above specification.

Hot Melt Layer

| | |
|---|---|
| Michelman 4983-40 R | 100% |

Metallic Layer

| | |
|---|---|
| Michem 4983-40 R (Michelman Inc.) | 60% |
| Silbercote Aq 3130-Fix (Silberline Inc.) | 40% |

Ink receiving layer

| | |
|---|---|
| Witcobond W-213 (Chemtura Inc.) | 40% |
| Polycup 172 (Hercules inc.) | 11% |
| Orgasol 3105 (Arkema Inc.) | 12% |
| IPA/water (1;1) | 37% |

### Example 4

The following media was prepared in three layers as described in the above specification.

Hot Melt Layer

| | |
|---|---|
| Tecseal E-428/50 (Trub Emulsion Chemie) | 100% |

Metallic Layer

| | |
|---|---|
| Michem 4983-40 R (Michelman Inc.) | 60% |
| Silbercote Aq 3130-Fix (Silberline Inc.) | 40% |

Ink receiving layer

| | |
|---|---|
| Witcobond W-213 (Chemtura Inc.) | 31% |
| Polycup 172 (Hercules inc.) | 20% |
| Orgasol 3105 (Arkema Inc.) | 12% |
| IPA/water (1:1) | 37% |

### Example 5

The following media was prepared in three layers as described in the above specification.

Hot Melt Layer

| | |
|---|---|
| Polvinyl Chloride | 62% |
| Dioctylphthalate | 34% |
| Dodecyl Benzene | 3% |
| Epoxidized soy oil | 0.75% |
| Zinc phophite | 0.25% |

Metallic Layer

| | |
|---|---|
| Michem 4983-40 R (Michelman Inc.) | 60% |
| Silbercote Aq 3130-Fix (Silberline Inc.) | 40% |

Ink receiving layer

| | |
|---|---|
| Witcobond W-213 (Chemtura Inc.) | 40% |
| Polycup 172 (Hercules inc.) | 11% |
| Orgasol 3105 (Arkema Inc.) | 12% |
| IPA/water (1:1) | 37% |

### Example 6

The following media was prepared in three layers as described in the above specification.

Hot Melt Layer

| | |
|---|---|
| Michelman 4983-40 R | 100% |

Metallic Layer

| | |
|---|---|
| Witco W-213 (Chemtura Inc.) | 60% |
| Silbercote Aq 3130-Fix (Silberline Inc.) | 40% |

Ink receiving layer

| | |
|---|---|
| Witcobond W-213 (Chemtura Inc.) | 32% |
| Polycup 172 (Hercules inc.) | 19% |
| Orgasol 3105 (Arkema Inc.) | 12% |
| IPA/water (1:3) | 37% |

### Example 7

The following media was prepared in three layers as described in the specification.

Hot Melt Layer

| | |
|---|---|
| Polyester P-600 (Twill USA) | 100% |

Metallic Layer

| | |
|---|---|
| Kraton D-113P (Kraton Inc.) | 18% |
| Silvex 440-15 D (Silberline Inc.) | 42% |
| Toluene | 40% |

Ink receiving layer

| | |
|---|---|
| Witcobond W-213 (Chemtura Inc.) | 40% |
| Polycup 172 (Hercules inc.) | 11% |
| Orgasol 3105 (Arkema Inc.) | 12% |
| IPA | 37% |

### Example 8

The following media was prepared in two layers by combining the metallic layer and the ink receiving layer as described in the above specification.

Hot Melt Layer

| | |
|---|---|
| Polyester P-600 (Twill USA) | 100% |

Ink receiving layer

| | |
|---|---|
| Witcobond W-213 (Chemtura Inc.) | 20% |
| Polycup 172 (Hercules inc.) | 5% |
| Orgasol 3105 (Arkema Inc.) | 12% |
| Silbercote Aq 3130-fix | 20% |
| IPA | 43% |

### Example 9

The following media was prepared in two layers by combining the melt layer and the metal as described in the specification.

Melt Layer/Metal layer

| | |
|---|---|
| Polvinyl Chloride | 30% |
| Dioctylphthalate | 25% |
| Dodecyl Benzene | 2% |
| Epoxidized soy oil | 1% |
| Silvex 440-15 D (Silberline Inc.) | 42% |

Ink receiving layer

| | |
|---|---|
| Witcobond W-213 (Chemtura Inc.) | 40% |
| Polycup 172 (Hercules inc.) | 11% |
| Orgasol 3105 (Arkema Inc.) | 12% |
| IPA | 37% |

### Example 10

The following media was prepared in three layers as described in the above specification.

Hot Melt Layer

| | |
|---|---|
| Polyester P-600 (Twill USA) | 100% |

Metal layer

| | |
|---|---|
| Polvinyl Chloride | 31% |
| Dioctylphthalate | 23% |
| Dodecyl Benzene | 2% |
| Epoxidized soy oil | 2% |
| Silvex 440-15 D (Silberline Inc.) | 42% |

Ink receiving layer

| | |
|---|---|
| Witcobond W-213 (Chemtura Inc.) | 40% |
| Polycup 172 (Hercules inc.) | 11% |
| Orgasol 3105 (Arkema Inc.) | 12% |
| IPA | 37% |

### Example 11

The following media was prepared in three layers as described in the above specification.

Hot Melt Layer

| | |
|---|---|
| Michelman 4983-40 R | 100% |

Metal layer

| | |
|---|---|
| Polvinyl Chloride | 31% |
| Dioctylphthalate | 23% |
| Dodecyl Benzene | 2% |
| Epoxidized soy oil | 2% |
| Silvex 440-15 D (Silberline Inc.) | 42% |

Ink receiving layer

| | |
|---|---|
| Witcobond W-213 (Chemtura Inc.) | 40% |
| Polycup 172 (Hercules inc.) | 11% |
| Orgasol 3105 (Arkema Inc.) | 12% |
| IPA | 37% |

### Example 12

The following media is prepared in two layers by combining the dual layers as described in Examples 8 and 9 and as described in the above specification.

Hot Melt Layer

| | |
|---|---|
| Polyester P-600 (Twill USA) | 100% |

Ink receiving layer

| | |
|---|---|
| Witcobond W-213 (Chemtura Inc.) | 20% |
| Polycup 172 (Hercules inc.) | 5% |
| Orgasol 3105 (Arkema Inc.) | 12% |
| Silbercote Aq 3130-fix | 20% |
| Polyester P-600 | 20% |
| IPA | 23% |

The present may be embodied in specific forms other than those particularly described above or illustrated by the appended drawings. Upon viewing the present application preferred embodiments and other descriptions herein of the present invention, variations and other implementations that do not depart from the spirit and scope of the present invention will be apparent to one of routine skill in this field. Such variations and other implementations are considered part of the present invention and within the scope of the appended claims. Accordingly, reference should be made to the appended claims, rather than to the forgoing specification and drawings, as indicating the scope of the present invention.

I claim:

1. A reflective sparkling semi-metallic, or metallic imaged or imageable media for applying to a textile, fabric or canvas receptor element having at least one surface with valleys or pores, or having at least one surface that is substantially smooth or textured, that can be adhered to by the imaged or imageable media, wherein the receptor element may be a flexible, semi-rigid or rigid textile, fabric, or canvas element, and wherein:
(i) the media includes a transfer sheet comprising a support having a first surface and a second surface and having at least one printable ink receiving media on the first surface, second surface, or both for recording a positive or negative image wherein the transfer sheet comprises a sparkly reflective semi-metallic or metallic substrate coated with a semi-opaque or opaque primarily organic, primarily inorganic or mixed organic and inorganic ink-receptive layer that remains opaque or is rendered semi-translucent or translucent upon recording of an ink image, upon curing of the media after imaging or both, and the ink receptive layer includes or is part of a coating capable of receiving a positive or negative image on the first or second surface of the support and the sparkly flakes are dispersed within an ink-receptive layer that is rendered semi-translucent or translucent upon recording of an ink image, upon application of heat, light or catalyzed curing, or both
(ii) the media comprises at least one printable ink receiving surface with a positive, a negative image, or both
(iii) the media optionally comprises a release sheet that may be removed or dry peeled from the media support in the absence of wet release prior to hand ironing, prior to using a heat press process, or prior to applying a light, heat or chemical catalyzed adhesive curing method after the when the image, or optionally the media comprises a removable layer that can be removed by dry peeling after heat pressing or otherwise curing,
(iv) the media comprises at least one surface that will adhere or can be made to adhere to a receptor element having a surface that is visually smooth or textured, and may contain valleys or pores,
(v) the media surface according to (iv) can optionally be covered by a non-stick prior to completion of manual or machine heat pressing or prior to applying a light or chemical catalyzed adhesive method and apply pressure, and
(vi) the non-stick cover sheet can be heat pressed to drive the dry peeled coating into the receptor element having valleys or pores, or force applied to it prior to or during application of a light, heat or chemical adhesive method to adhere the imaged or imageable media to the element.

2. An imaged media according to claim 1, which can be applied to a textile, fabric or canvas receptor element article by use of a hand-held heat transfer device that is available to an ordinary consumer or can be affixed to already manufactured textile, fabric or canvas receptor elements by applying one or more of heat, light or chemical catalyzed adhesive methods to the sparkling metallic or metallic image comprising a thermoplastic substrate layer formed as a pluralistic single layer upon a peel-off transfer backing, wherein the thermoplastic substrate layer comprises metallic powder, metallic flakes, metallic particles, or metallic-like reflective particles, in combination with the ink receptive components to produce a single layer with a removable transfer backing, wherein the imaged media comprises:
(i) a transfer sheet comprising a support (such as a release paper) having a first surface and a second surface and having an imaged printable ink-jet or silk screen image receiving layer for recording a positive or negative sparkling, reflective, luminescent, semi-metallic, or metallic image wherein the imaged media comprises a sparkling, reflective, luminescent, semi-metallic or metallic substrate coated with a semi-opaque or opaque coating, primarily comprised of organic particles and thermoplastic polymers and optionally containing inorganic pigment containing organic particles, ink-receptive layer that is rendered opaque to translucent upon recording of an ink image thereon or therein, and a coating capable of receiving an image on the first or second surface of the support,
(ii) the imaged media comprises a positive or negative digital image that was created upon the media by using an inkjet printer, and
(iii) the imaged media optionally comprises a dry peeling coating or a wet release coating that may be removed prior to hand ironing or before applying a light or chemical catalyzed adhesive method when the image is a positive, or may be optionally dry peeled after heat pressing if the image is a negative image.

3. A media according to claim 1, which comprises an ink jet or silk screen printable substrate having from at least two layers, and further comprises:
(a) a thermoplastic transfer substrate layer over a release paper or a similar type peel off transfer backing (i) covered by a reflective metallic powder or metallic flakes, metallic layer or other metallic coating, (ii) having metallic powder, metallic flakes, metallic particles, or metallic like reflective particles incorporated into the thermoplastic transfer substrate layer of the media, or (iii) both (i) and (ii), and
(b) an inkjet receptive coating, layer or laminate covers the curable or non curable thermoplastic layer comprising thermoplastic organic particles, and optionally comprising inorganic pigments other ink receptive polymers as binder, cross linkers, and additives such as surfactants, dispersing agent, plasticizers, and other acceptable functional and non-functional additives.

4. The media according to claim 2, wherein the thermoplastic substrate layer comprises a pluralistic single layer upon a peel-off transfer backing that is capable of recording a positive or negative image, and wherein the thermoplastic substrate layer further comprises the metallic powder or metallic flakes in combination with ink receptive components to provide a sparkly thermoplastic layer and comprise a single layer that can be produced by one or more coatings of a single layer composition upon a removable transfer backing.

5. The media according to claim 2, comprising an inkjet or silk screen printable substrate that has three layers formed upon a peel-off removable backing, wherein the layer next to the peel-off backing is an element adhering layer that is (i) a thermoplastic layer, which can be softened with the heat from a regular fabric ironing device, or (ii) is a light, chemical or heat adhering layer that comprises a light, heat or chemical curable composition, and the top layer is a porous ink jet or silk screen printable layer, and wherein at least one layer located substantially in between the ink jet or silk screen printable layer and the adhering layer is a metallic layer that is formed by applying a curable or dryable solution that is a liquid or gel and the liquid or gel that comprises metallic power, flakes or metallic-like reflective particles, applying metallic particles by metallic sputtering, or applying a metallic laminate layer that may or may not contain a thermoplastic binder.

6. A recordable or recorded transfer media comprising an inkjet or silk screen printable thermoplastic layer that is a sparkly layer comprising one or more of a metal power, metallic flakes, metallic particles, or metallic like reflective particles, as a single or multilayer printable substrate, which does not require a peel-off backing and may be appended to a fabric by utilizing the heat of a normal iron or a similar heating process, wherein one surface comprises a thermoplastic layer that is also constructed as an inkjet receptive layer that permits the printing of a positive or negative image upon the thermoplastic surface that will be visible as a positive image once the substrate has been applied to the fabric, and the surface where the positive image may be view may be translucent, semi-translucent, or semi-opaque.

7. The media according to claim 6, wherein the media comprise a sealing coating, a protective coating, or both that are applied to the printed media after the printed media is affixed to a textile, fabric or canvas.

8. A kit for applying a media according to claim 1 that is adapted for affixing to a textile, canvas or fabric sheet or article that is smooth or textured and may comprise valleys or pores by a heat transfer method, wherein the kit comprises at least one media substrate according to claim one that is already imaged or may be imaged by an inkjet printing or silk screen procedure, and at least one protective heat transfer sheet that can be applied between at least one surface of the media and a hand held heat device while the media substrate is being affixed to a textile, canvas or fabric sheet to avoid damaging or smudging the imaged substrate, and may optionally contain a container or article for applying a protective coating to the imaged media after it has been applied to the textile, canvas or fabric sheet or article.

9. A kit according to claim 8, comprising that may be affixed to a textile, canvas or fabric sheet or article by utilizing a hand-held heat transfer device that is available to an ordinary consumer to modify already manufactured textile, canvas or fabric sheet or article of commerce by applying the a sparkling, reflective, luminescent, semi-metallic, sparkling metallic or metallic image to the textile, canvas or fabric sheet or article receptor element.

10. A kit according to claim 9, wherein the receptor element has valleys or pores and the kit further comprises at least one transfer sheet medium comprising a support or release paper having a first surface and a second surface and having printable ink or silk screen image receiving layer for recording a positive or negative reflective, luminescent, semi-metallic, or metallic image wherein the imaged media comprises a light-emitting, reflective, luminescent, holographic, semi-metallic, sparkling or metallic substrate coated with a semi-opaque or opaque coating, primarily comprised of organic particles and thermoplastic polymers and optionally containing inorganic pigment containing organic particles, ink-receptive layer that is rendered opaque to translucent upon recording of an ink image thereon or therein, and a coating capable of receiving an image on the first or second surface of the support and the coating may be imaged with a positive or negative digital image using a printer or silk screen process, and the coating can be dry peeled from the support in the absence of wet release prior to hand ironing.

11. A kit for applying a media according to claim 6 that is adapted for affixing to a textile, canvas or fabric sheet or article that is smooth or textured and may comprise valleys or pores by a heat transfer method, wherein the kit comprises at least one media substrate according to claim one that is already imaged or may be imaged by an inkjet printing or silk screen procedure, and at least one protective heat transfer sheet that can be applied between at least one surface of the media and a hand held heat device while the media substrate is being affixed to a textile, canvas or fabric sheet to avoid damaging or smudging the imaged substrate, and may optionally contain a container or article for applying a protective coating to the imaged media after it has been applied to the textile, canvas or fabric sheet or article.

12. A kit for applying a media according to claim 1 that is adapted for affixing to a textile, canvas or fabric sheet or article that is smooth or textured and may comprise valleys or pores by a light or chemical adhesive method, wherein the kit comprises at least one media substrate according to claim 1 that is already imaged or may be imaged by an inkjet printing or silk screen procedure, and at least one protective heat transfer sheet that can be applied between at least one surface of the media and during at least part of the time that a light or chemical adhesive method is being applied to the media substrate to affix it to a textile, canvas or fabric sheet to avoid damaging or smudging the imaged substrate, and may optionally contain a container or article for applying a protective coating to the imaged media after it has been applied to the textile, canvas or fabric sheet or article, wherein the media further comprises polymeric organic particles, polymer binders and other additives such as surfactant and dispersing agent.

13. A kit according to claim 12, wherein the ink printable or silkscreen printable substrate comprises an ink receptive layer that contains inorganic pigments.

14. A kit according to claim 12, comprising an ink printable or silk screen printable substrate, wherein the organic polymeric particles are polyolefin, polyamide, polyacrylates, polyvinyls and polyester or their copolymer particles and may optionally further include one or more, cross-linker agents and inorganic porous pigments.

15. A kit according to claim 14, comprising an ink printable or silk screen printable substrate, wherein the organic particles comprise substantially porous thermoplastic particles having a high surface area to better absorb water and water-miscible solvents that are often contained in aqueous-based inks, wherein the particles may have a particle size distribution containing particles with a diameter size in the range of 1 μm to 200 μm.

16. A kit according to claim 15, comprising an ink printable or silk screen printable substrate, wherein the ink receptive layer comprises at least one polyurethane, polyacylate, polyolefins and polyvinyls and its copolymer, or polyester binder that is capable of binding porous organic polymeric particles and the ink-receptive layer is capable of absorbing aqueous-based inks from an ink-jet printer to form an image, and may optionally include crosslinkers or binders compatible with the other components of the ink receptive layer that are selected from group of thermoplastic polyurethanes, polyesters polyamides, copolymers of polyethylene, polyethylene waxes, including commercially available polyurethanes or polyesters or their copolymers that can be heat melted or fused with receptor surface by hand ironing or heat pressing.

17. A kit according to claim 16, comprising an ink printable or silk screen printable substrate, wherein the inks used in the ink-jet printing devices are aqueous-based inks containing molecular dyes or pigmented colorants wherein water is a major component and the aqueous-based inks may further include amounts of water-miscible solvents such as glycols and glycol ethers.

18. A kit according to claim 11, wherein the ink printable or silk screen printable substrate comprises a thermoplastic substrate layer that is formed as a pluralistic single layer capable of recording a negative or positive image, wherein the thermoplastic layer is formed upon a peel-off transfer backing and either or both of the thermoplastic and ink receptive substrate layers further comprise metallic powder, metallic flakes, or another metallic like-reflective components to produce a sparkling two layer or single layer media with a removable transfer backing.

19. A kit according to claim 18, wherein the ink printable or silk screen printable substrate comprises a two layer substrate on a removable peel-off transfer backing.

20. A kit according to claim 18, wherein the ink printable or silk screen printable substrate comprises a single layer substrate on a removable peel-off transfer backing.
